(19) United States
(12) Patent Application Publication
(10) Pub. No.: US 2019/0248492 A1
(43) Pub. Date: Aug. 15, 2019

(54) DRONE

(71) Applicant: Sylvain ROLDAN DE PERERA, Larmor Plage (FR)

(72) Inventor: Sylvain ROLDAN DE PERERA, Larmor Plage (FR)

(21) Appl. No.: 16/322,557

(22) PCT Filed: Jul. 26, 2017
(86) PCT No.: PCT/EP2017/068852

§ 371 Date: Apr. 25, 2019

(30) Foreign Application Priority Data
Aug. 2, 2016 (FR) 1657499

(51) Int. Cl. B64D 1/02; B64C 39/02; B64C 27/37; B64C 27/50; B64C 3/56; B64C 3/40; B64C 9/08

(52) U.S. Cl. CPC B64D 1/02; B64C 39/024; B64C 27/37; B64C 27/50; B64C 3/56; B64C 3/40; B64C 2009/005; B64C 2201/021; B64C 2201/024; B64C 2201/08; B64C 2201/102; B64C 2201/108; B64C 2201/12; B64C 9/08

(57) ABSTRACT

An assembly comprising a drone (1) and at least one releasable load (37) mounted on the drone, the drone comprising an on-board data processing system, the releasable load (37) comprising at least one sensor delivering a piece of information that can be used to ascertain the path of same and actuators for controlling flight control surfaces allowing it to be oriented as it falls, being linked to the drone (1) by an optical fibre (70), the load and the drone being arranged to exchange information via the optical fibre while the load is falling, the load transmitting data originating from said at least one sensor and the drone transmitting data for controlling the actuators, established taking into account that received from the load, in order to guide the load towards a predefined target.

The present invention relates to drones and more specifically, but not exclusively, those used for jettisoning at least one load onto an objective.

For example, this may be a load containing equipment for first aid at an accident site, the invention not being limited to a specific load.

Directing the load toward the objective during the descent thereof particularly implies compensating for the drift thereof associated with the wind and taking into account the positional deviation between the aerial carrier and the objective thereof.

The payloads used today have an integral navigation system, which presents a high degree of complexity, involving a high price which limits the civil applications.

Therefore, there is a need for a compact drone and jettisonable load assembly that may provide precise guiding toward the target at a modest cost.

According to a first aspect thereof, the aim of the invention is to meet this need through an assembly including a drone and at least one jettisonable load installed on board the drone, the drone including an on-board data processing system, the jettisonable load including at least one sensor delivering information that may be used to ascertain the trajectory thereof and actuators for controlling flight control surfaces allowing it to be oriented as it falls, the jettisonable load being connected to the drone by an optical fiber, the load and the drone being arranged to exchange information via the optical fiber while the load is falling, the load transmitting data originating from said at least one sensor and the drone transmitting operating data to the actuators, established taking into account the data received from the load, in order to guide the load toward a predefined objective.

Using the computing power on board the drone, it is possible, thanks to this first aspect of the invention, to reduce the complexity of the electronics of the load and therefore the cost thereof, without losing guiding accuracy.

The load may be provided with sensors which provide information on the accelerations to which it is subjected during the descent thereof, and the drone may compute the descent trajectory thereof and the divergence with respect to the target and determine the controls to be sent to the actuators of the flight control surfaces of the load in order to accurately direct it toward the objective.

These exchanges of data between the drone and the load take place practically without a transmission delay due to the use of the optical fiber, which may be multimode.

The drone may include a hold and this may contain several jettisonable loads. The hold may be placed at the front of the drone. The length of the optical fiber may be greater than or equal to 3000 m.

Moreover, the use of drones raises the problem of the recovery thereof in the absence of a landing strip.

One solution involves using a parachute which is opened at the end of a mission. However the parachute, due to the weight thereof, reduces the range and/or the payload and, furthermore, makes recovery more difficult when there is strong wind.

As a result, there is a need to facilitate the recovery of the drone at the end of a mission.

The aim of the invention, according to a second aspect thereof, is to meet this need, through a drone including:
a fuselage,
two wings configured to move from a flight configuration where the wings form a fixed wing unit, to a recovery configuration where the wings form a rotary wing unit or a recovery configuration where, through the orientation of the wings with respect to the fuselage, they cause the latter to revolve on itself around the longitudinal axis thereof.

This aspect of the invention is independent from the previous aspect, linked to the communication between the load and the drone, but may nevertheless be advantageously combined therewith.

Changing the configuration of the wing unit allows the drone to be recovered when there is no landing strip, with a possibility of having a relatively accurate landing, even when there is strong wind.

The wings are preferably borne by a support structure which may rotate relative to the fuselage, the support structure being blocked against rotation when the wings are in the flight configuration (fixed wing unit) and rotating when the wings are in the recovery configuration, the wings then forming a rotor turning relative to the fuselage. The wings are advantageously rotated by the main rotor.

In an alternative, the wings are not borne by a structure that may rotate relative to the fuselage, but may, in the recovery configuration, assume angles of incidence in order to make the fuselage self-rotate as the drone falls. The leading edge of the two wings may assume an orientation of approximately 90° with respect to the fuselage. Then, close to the ground, the angle of incidence of the wings may be modified in order to slow down the drone.

The wings may be connected in a hinged manner to the fuselage, and be configured to move from a launch configuration where the wings are folded down along the fuselage to the flight configuration where the wings are opened out.

The wings preferably have a variable geometry in the opened-out configuration.

The wings may be arranged to form a forward-swept wing unit in the flight configuration. The wings may also be arranged to form a straight wing unit in the flight configuration.

The wings may rotate such as to assume a reverse angle of incidence with respect to one another in the recovery configuration.

In the recovery configuration, the wings may be rotated with the support structure by the propulsion motor. This rotation takes place, for example, in the opposite direction of the propeller. The structure for supporting the wings may be coupled to the main motor using a mechanism provided to change the drone from a configuration where the rotating structure is locked with respect to the fuselage on the to a configuration for rotation with respect to the fuselage.

Moving from the locked configuration to the unlocked configuration may take place by axial movement of a locking system under the effect of at least one actuator. This axial movement may particularly include a movement of the transmission shaft connecting the propulsion motor to the propeller.

The wings are preferably connected to the support structure by a connection offering several degrees of freedom, preferably three degrees of freedom, and particularly a rotation around a first axis fixed relative to the wing, making it possible to modify the bearing angle, i.e. the angle between the longitudinal axis of the wing and that of the fuselage.

The drone includes, in a preferred embodiment, two wings, the roots of which are mobile in a direction perpendicular to the longitudinal axis of the fuselage. The roots may move from a low position to a high position.

The low position makes it possible to bring the center of gravity of the wings closer to the longitudinal axis of the fuselage, which is desirable when the wings are in the recovery configuration (rotary wing unit) with a reverse pitch to one another.

The high position is preferred when the wings are in the flight configuration (fixed wing unit).

The movement from one configuration to the other may take place thanks to telescopic columns for supporting the root of the wings. The columns are, for example, opened out under the effect of at least one actuator and/or under the effect of lift.

Preferably, the telescopic columns may rotate, such as to be able to azimuthally (bearing-wise) rotate the wings from the folded-down configuration along the fuselage to the flight opened-out configuration. Preferably, the wings have a roll degree of freedom in order to change the opening angle thereof and tilt the leading edge from the front toward the rear. The rotation in the roll axis of the wings may take place thanks to a single motor and to a transmission mechanism which makes it possible to selectively couple this motor to either or both of the columns. This transmission mechanism may include a pinion mobile on the axle thereof which is moved under the action of an actuator in order to mesh with pinions for driving the columns According to the position of the pinion mobile on the axle thereof, it is possible to rotate either or both of the pinions for rotating the columns.

The drone may include reinforcing guides inside which the columns are at least partially placed.

A ratchet mechanism may be provided in association with each column in order to prevent the return movement of the wings toward the configuration thereof where they are folded down along the fuselage.

The roots may be locked in the high and/or low position by a locking mechanism. In an exemplary embodiment, locking is provided by the movement of an element which may take place when the aforementioned locking system of the rotating structure is actuated in order to bring the wings into the recovery configuration, where they revolve with the rotating structure around the fuselage. This element may move axially with the transmission shaft.

The drone may be arranged such as to allow the wings to be brought back to the low position by turning over the rotating structure for supporting the wings by 180° about the longitudinal axis of the fuselage. The weight of the fuselage then tends to retract the columns.

The drone advantageously includes, as mentioned above, a locking system which makes it possible to lock/unlock the rotating structure for supporting the wings with respect to the rest of the fuselage.

The rotating structure may include a rotating segment mounted on bearings which rotationally guide it with respect to the rest of the fuselage. In the locked position of the segment, the latter is fixed with respect to the rest of the fuselage.

It is advantageous that the segment may be rotated relative to the rest of the fuselage by an auxiliary motor, separate from the propulsion motor. This auxiliary motor is preferably a stepping motor. The rotation of the segment relative to the rest of the fuselage may make it possible to direct the drone, particularly when the normally used flight control surfaces fail. This represents a safeguard. This rotation of the wings which is controlled by the auxiliary motor also makes it possible to pivot the wings by 180° in order to bring them into the low position where the columns are retracted, as is mentioned above.

The system for locking the rotating structure may be configured to assume an intermediate configuration where the auxiliary motor may drive the rotating structure.

For example, the locking system includes an inner sun gear which may be rotated by the auxiliary motor, and a planet carrier which includes planet gears axially mobile on the rotation axle thereof between a free position and a blocked position. These planet gears mesh moreover with a ring gear which forms an outer sun gear revolving with the rotating structure.

In the fixed wing unit flight configuration, the rotating segment is blocked thanks, for example, to a dog connection between the aforementioned ring gear and the fuselage or a structure which is rotationally fixed with respect to the fuselage.

The transmission shaft is in a position where, axially, it is moved as far as possible toward the propeller.

In the recovery configuration, the shaft is moved as far as possible toward the propulsion motor.

Preferably, the drone includes a first coupling between the propeller and the shaft which is uncoupled when the shaft is moved to assume the position that it occupies in the recovery configuration.

Also preferably, the drone includes another coupling between the rotating structure and the transmission shaft which allows a coupling between the shaft and the rotating structure when the shaft is moved in order to assume the position that it occupies in the recovery configuration.

The system for locking the rotating structure may be arranged such that, in the intermediate configuration, the shaft and the propeller are coupled and the shaft and the rotating structure are not coupled.

In the intermediate configuration, the auxiliary motor is coupled to the rotating structure. This may be achieved by bringing the aforementioned planet gears into the blocked position, by axially moving the planet carrier together with the axial movement of the transmission shaft.

The locking system may include a driving piece which is axially moved with the transmission shaft and which is rotated by the auxiliary motor. This driving piece may include pins engaged in the central sun gear such as to rotate it in the intermediate configuration. These pins may include flexible tongues which frictionally engage the planet carrier such as to be able to move it axially while allowing the planet carrier to escape therefrom when the movement of the driving piece continues beyond the travel necessary to move the planet gears over the axle thereof.

In the intermediate configuration, the planet gears are blocked on the axle thereof and the rotation of the driving piece having pins under the effect of the auxiliary motor may be transmitted to the outer ring gear of the rotating segment.

In the recovery configuration (rotary wing unit), the pins of the driving piece are disengaged from the inner sun gear.

The drone preferably includes, at the front, an impact absorbing nose, particularly made up of two combined polymer materials, namely a viscoelastic polymer, for example urethane, coating the nose and a “non-Newtonian” polymer or shear thickening fluid, held by the first polymer. As a result, the energy of an impact may be dispersed between the two materials.

The drone may include canards at the front. Preferably, at least one of the ailerons may rotate on itself. This aileron may be rotatable, being rotated in order to revolve on itself in order to apply a counter-rotation moment on the fuselage when the wings form said rotary wing unit.

The drone may include stabilizers which are only opened out during certain flight stages, particularly when jettisoning the loads. When opened out, these stabilizers are placed between the canard ailerons and the wings.

These stabilizers may help improve lift and may be arranged, once opened out, to attach to the wings, and then form, with the wings, a so-called “diamond” wing unit.

Preferably, the drone includes an air brake which may be brought out during flight and the movement of which under the effect of the relative wind is used to retract the stabilizers. The air brake may move longitudinally and drive a part of the fuselage rearward.

This air brake, once opened out, may move along at least one rail and rotate, via a ratchet unidirectional connection, the stabilizers in order to return them into the housing thereof, once, for example, the loads have been jettisoned.

The aforementioned connection is such that the reverse movement of the air brake may take place once the stabilizers have returned, without causing them to come out.

The use of an air brake is advantageous in that it makes it possible to avoid the use of powerful, heavy and cumbersome actuators. The air brake makes it possible to utilize the force of the relative wind, which pushes it in the opposite direction to that in which the drone advances.

The air brake may be pushed out of a corresponding housing, provided at the front of the drone, above the hold for storing the loads, by an actuator, particularly a linear actuator.

The air brake may be opened out by pivoting on itself, in order to form an angle of approximately 90° with respect to the longitudinal axis of the drone.

The air brake may be rigidly connected to at least one rack which meshes with at least one corresponding ratchet wheel, the rotation of which controls the return of the stabilizers.

The stabilizers may be housed between the loads in the returned configuration, and this improves the retention of the loads with regard to the acceleration experienced when launching. The stabilizers particularly make it possible to block a barrel bearing the loads inside the drone against rotation. Preferably, when blocked by the stabilizers, the hold containing the loads is not aligned with a hatch for ejecting the loads. The loads may not therefore be accidentally ejected when the stabilizers are in the returned position.

The air brake may be mounted in a pivoting manner on a carriage which moves over one or more fixed rails placed inside the fuselage. The air brake may bear a runner inside which a sliding element may move.

This sliding element may be connected by at least one connecting rod to a carriage which moves over the same rails as the air brake. The movement of the carriage, combined with that of the sliding element relative to the runner of the air brake, allows the latter to be folded down into the housing thereof when it is brought back to the original configuration thereof.

An actuator may be used to remove the air brake from the housing thereof.

Another problem that may arise when using a drone launched from a tube is the deployment of the drone on site. Indeed, it is desirable in some circumstances for the drone to be able to intervene quickly.

One solution for reducing the intervention time of the drone consists in constantly having a drone flying above the intervention location. This solution is complex and costly to implement since it entails the provision of a large number of drones, of the personnel that can carry out launches and recoveries, and moreover the constant presence of drones in the sky is not always desirable for reasons of discretion and/or air safety.

The aim of the invention, according to another aspect thereof, independently or in combination with the above, is to propose a solution allowing the rapid intervention of a drone.

This is achieved by the invention thanks to a drone at least partially housed, before taking off, in a launch tube provided with a propelling charge. The latter includes, for example, two reactive compounds which, when mixed, produce a gas release, which is given off suddenly once a certain pressure is reached in order to eject the drone.

The launch tube may be buried at least partially in the ground, to await the launch of the drone.

The launch tube may be sealed using an ejectable or pivoting cover.

The tube may be provided on the outer surface thereof with a threading which facilitates the burial thereof by means of screwing.

The tube may include a thermal charge, furthermore called an incendiary charge, which, when lit, causes the destruction of the drone. The tube may be provided with at least one sensor that may detect an unauthorized attempt to move and/or open it, and with a control means for causing the thermal charge to light in the case of an unauthorized attempt to access the inside of the tube or to transport it. The tube may be supplied with at least one accelerometer.

Thus, the drone remains protected against unauthorized access to the content of the tube through the presence of the thermal charge which ensures the self-destruction thereof.

Moreover, the tube may communicate data with an external terminal and provide information on movements undertaken close by.

The tube may be ceramic, in order to resist the heat given off by the thermal charge. The tube is preferably made such as to contain the energy of the thermal charge for a sufficient duration for it to destroy the drone.

The invention may be better understood upon reading the following description, of nonlimiting examples for the implementation thereof, and upon examining the appended drawing, wherein:

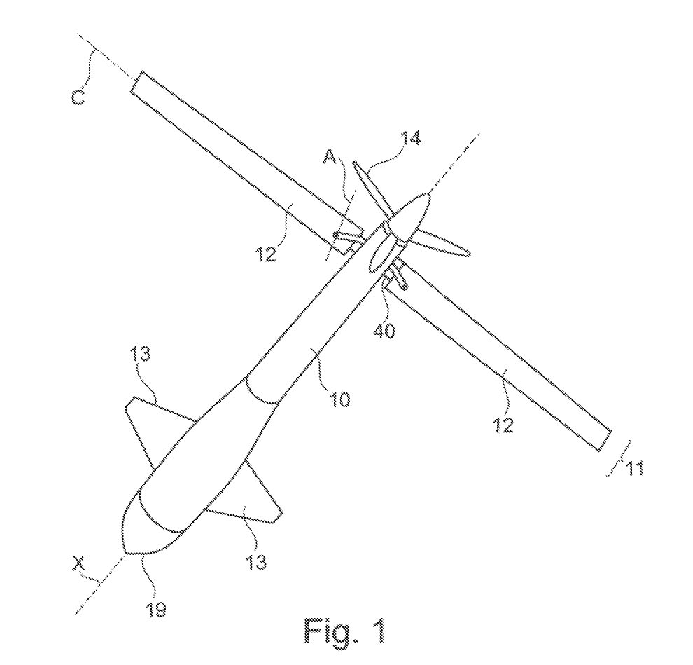

FIG. 1 schematically shows a drone according to an example of implementing the invention, in the slow flight configuration,

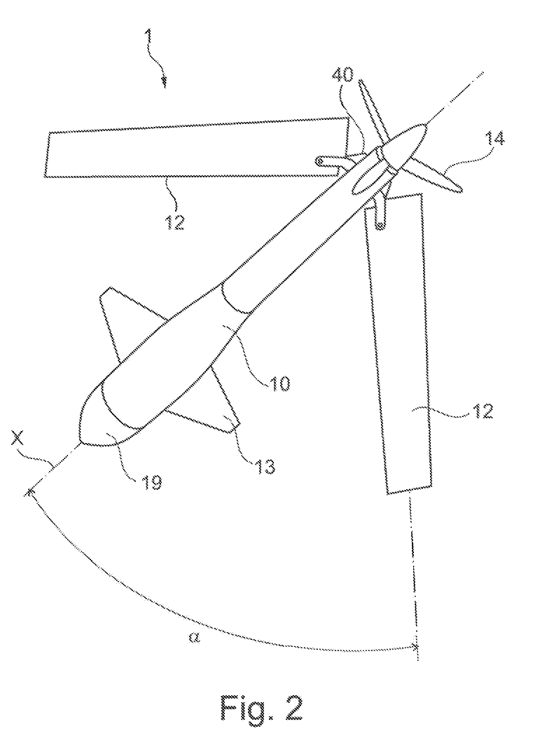

FIG. 2 shows the drone of FIG. 1 in the fast flight configuration,

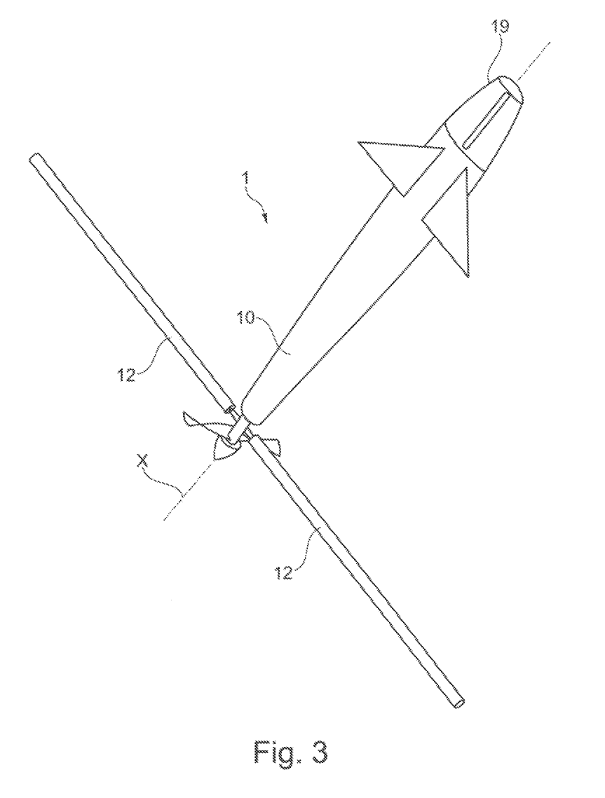

FIG. 3 shows the drone of FIGS. 1 and 2 in the recovery configuration,

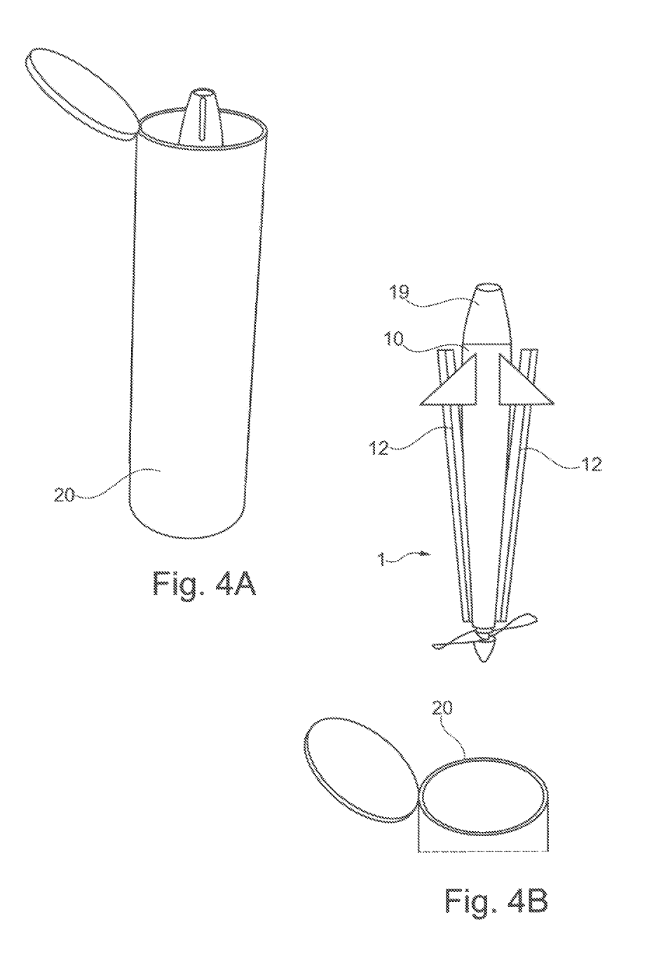

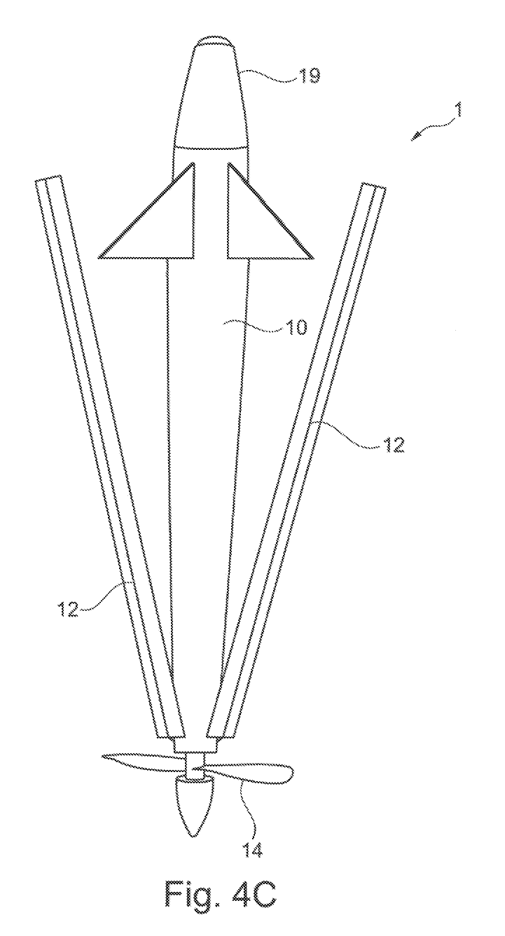

FIGS. 4A to 4C show the drone of FIGS. 1 to 3 when it is being launched,

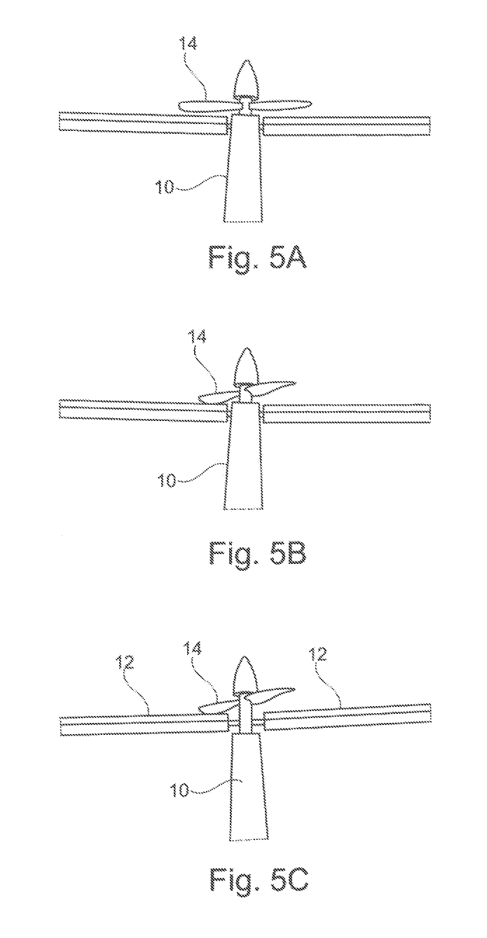

FIGS. 5A to 5C illustrate the passage of the wings in the recovery configuration,

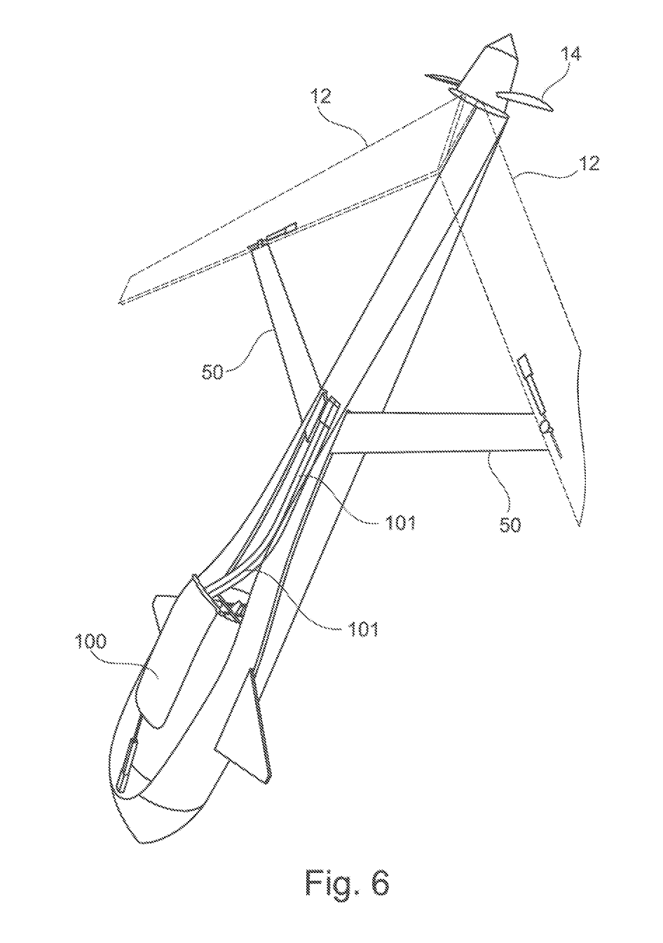

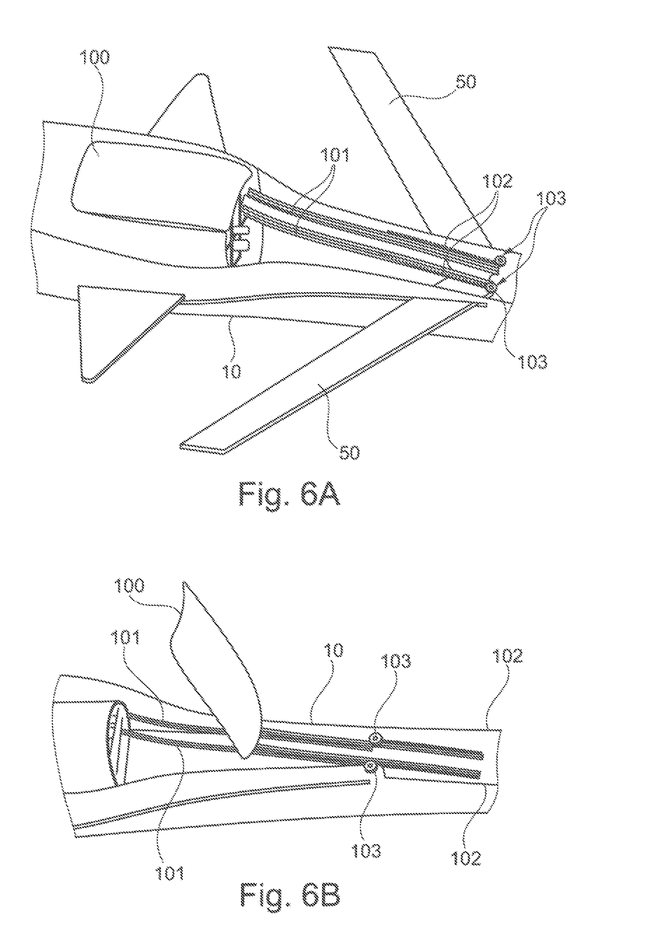

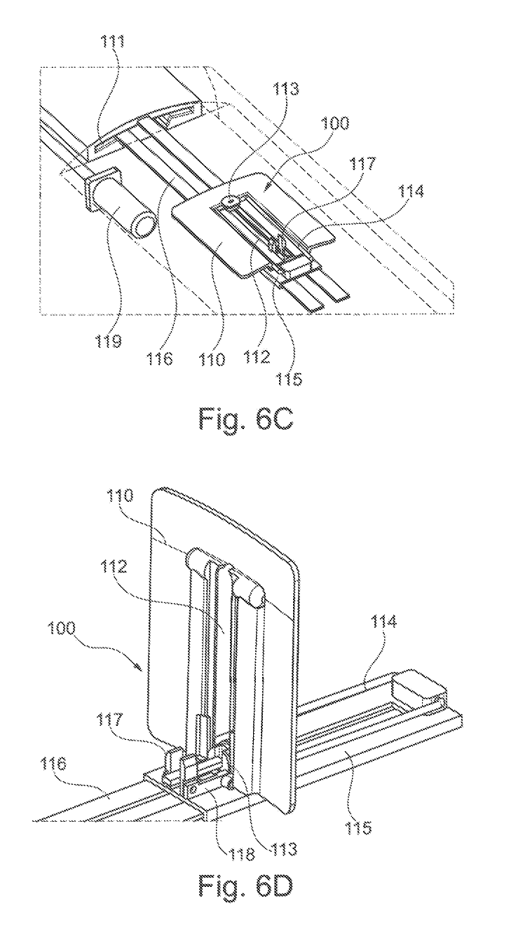

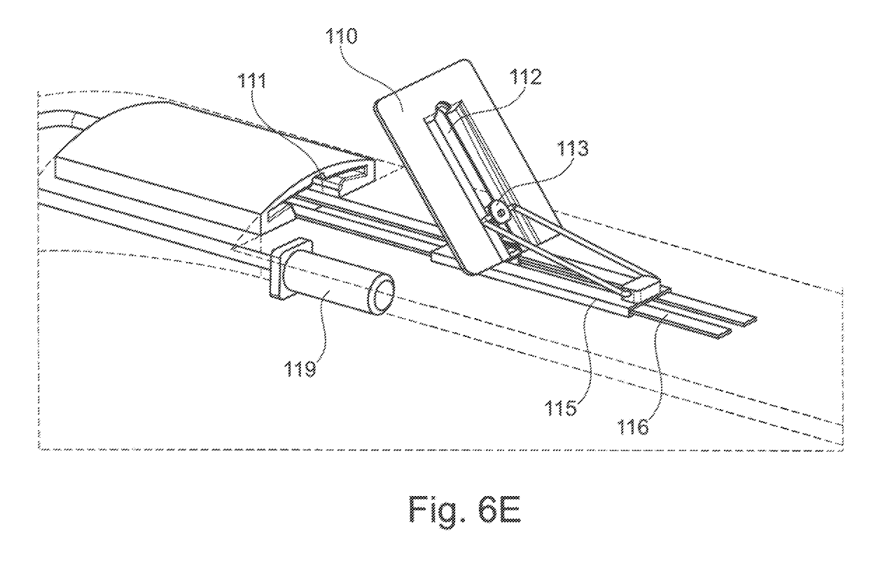

FIG. 6 shows an alternative drone with stabilizers and an air brake, the stabilizers being shown attached to the wings,

FIGS. 6A and 6B illustrate the air brake being opened out and being used for return of the stabilizers,

FIGS. 6C to 6E show an alternative embodiment of the air brake,

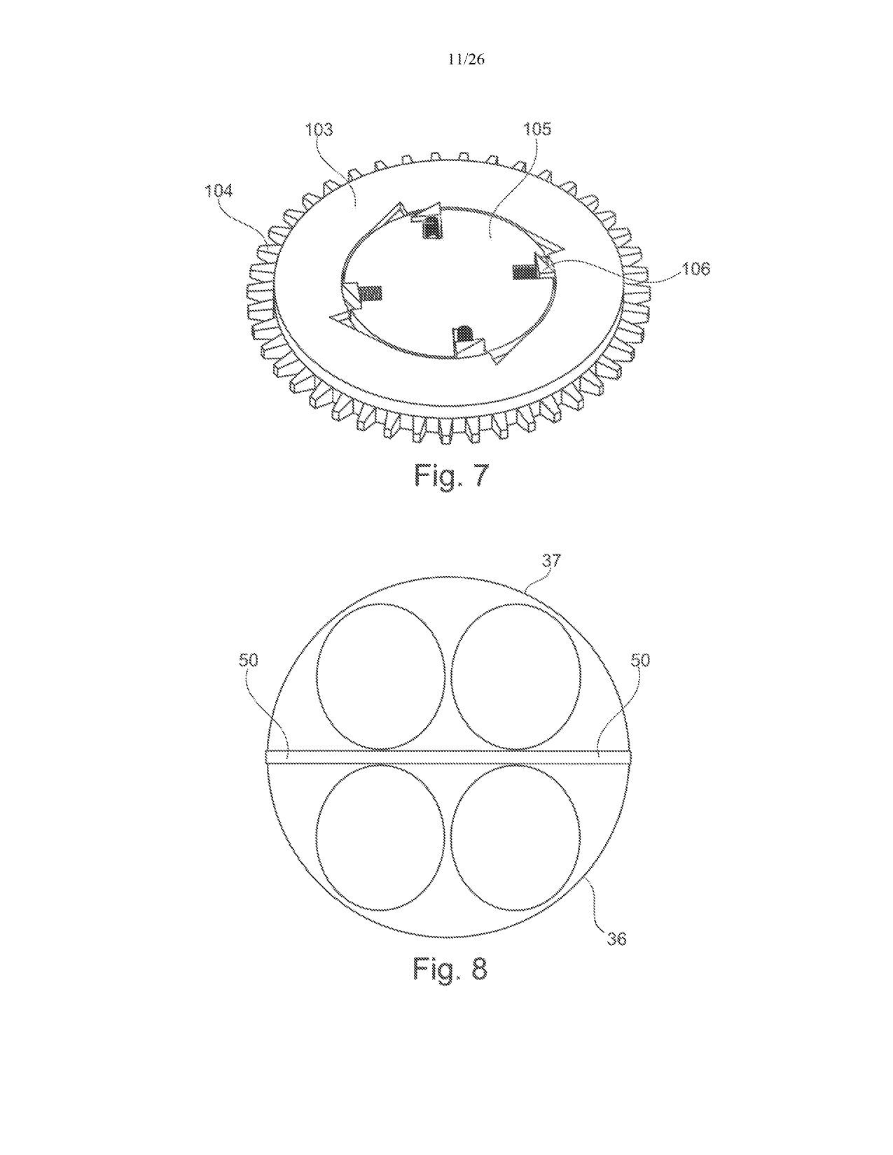

FIG. 7 shows, in isolation, a ratchet wheel for controlling the return of a stabilizer,

FIG. 8 is a schematic section illustrating the positioning of the stabilizers between the loads before they are opened out,

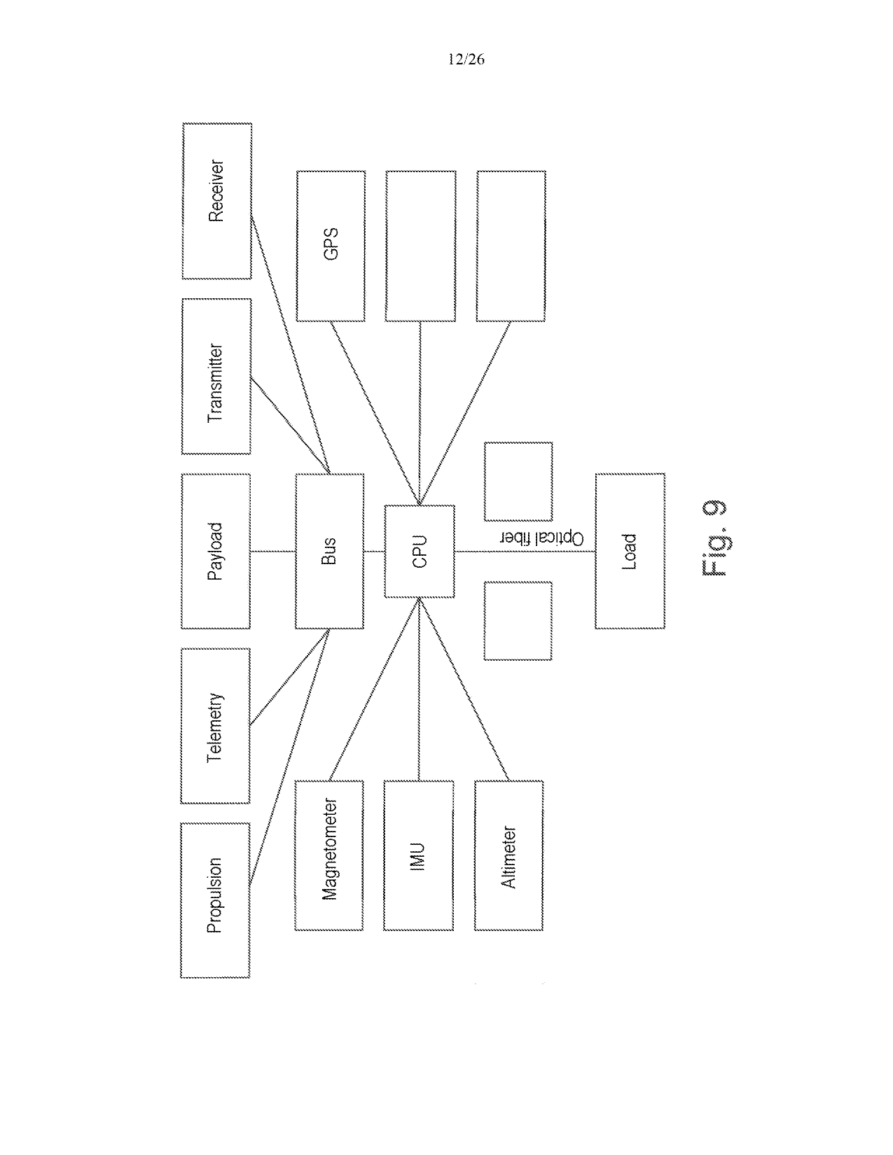

FIG. 9 schematically shows various constituent elements of the navigation platform,

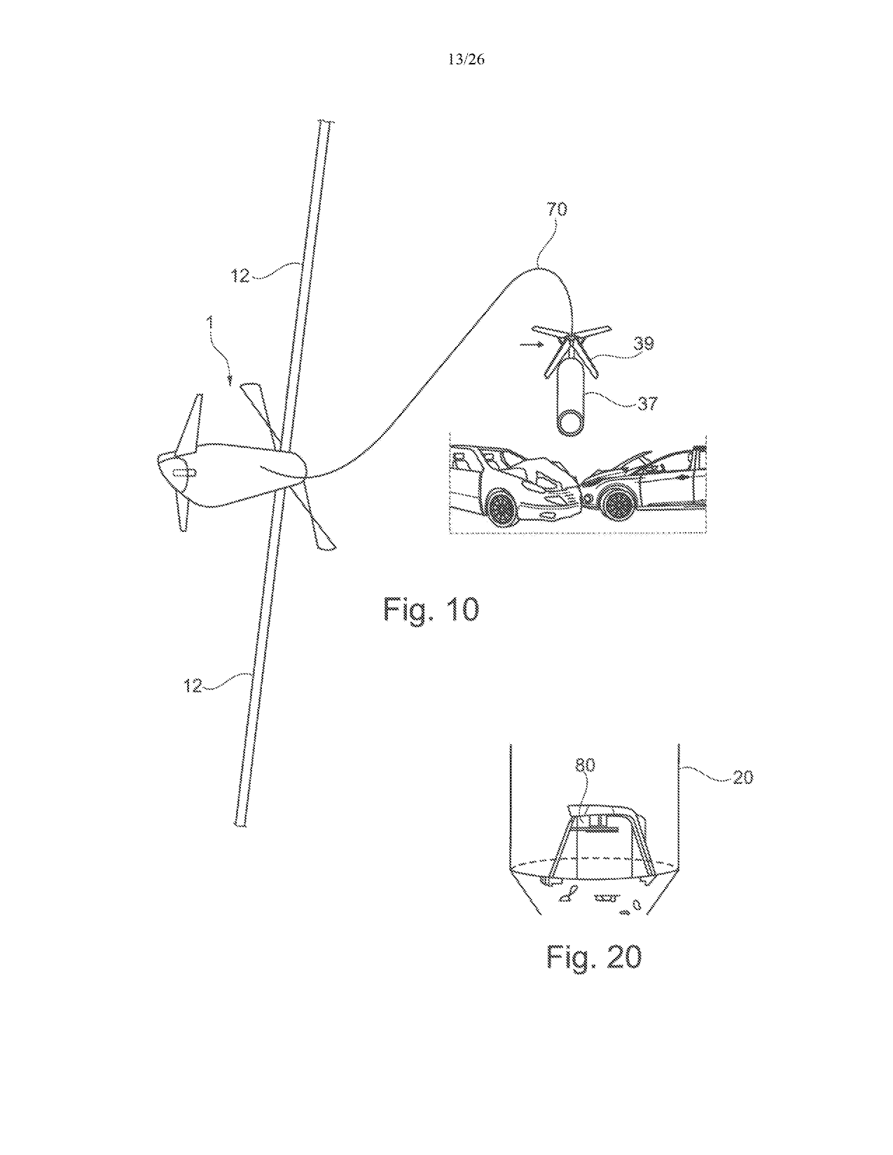

FIG. 10 illustrates the jettisoning of a wire-guided load,

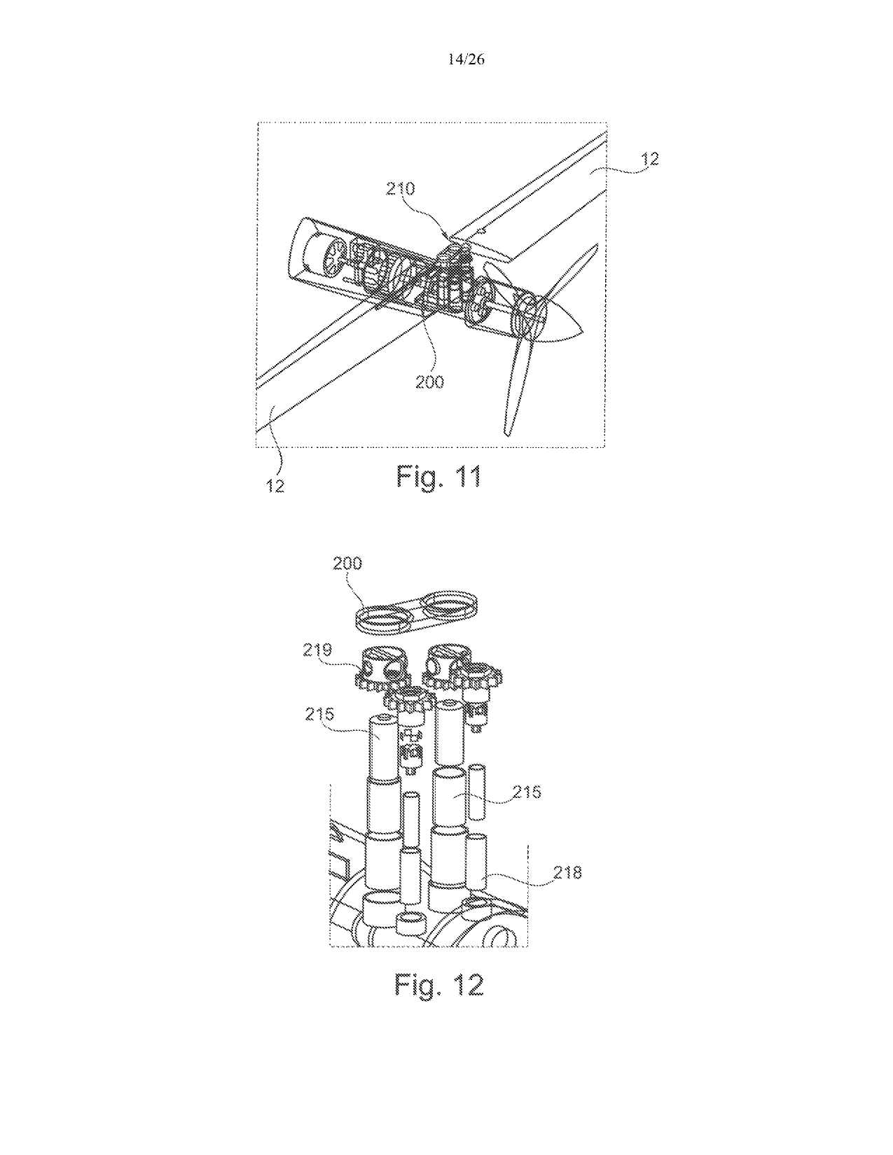

FIG. 11 is a partial and schematic view of an alternative drone according to the invention,

FIG. 12 is an exploded view of the mechanism for supporting the root of the wings,

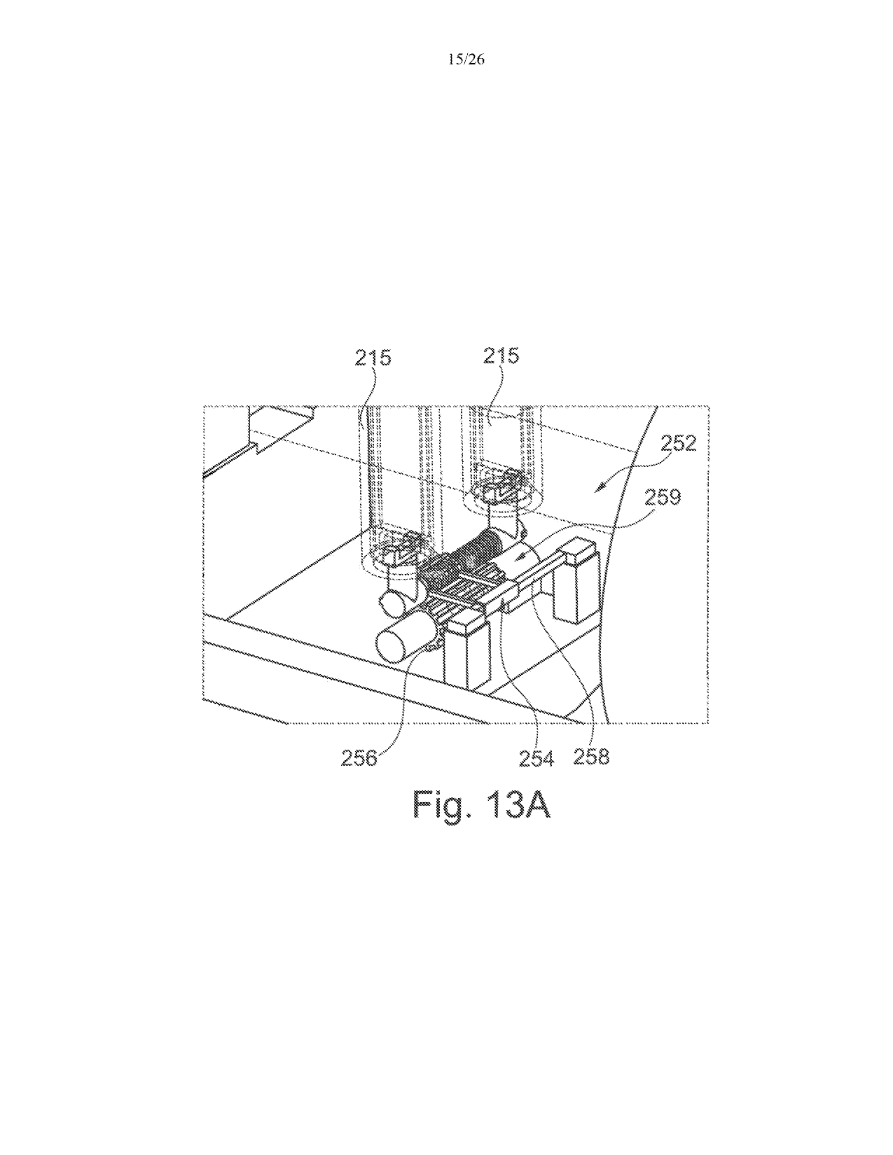

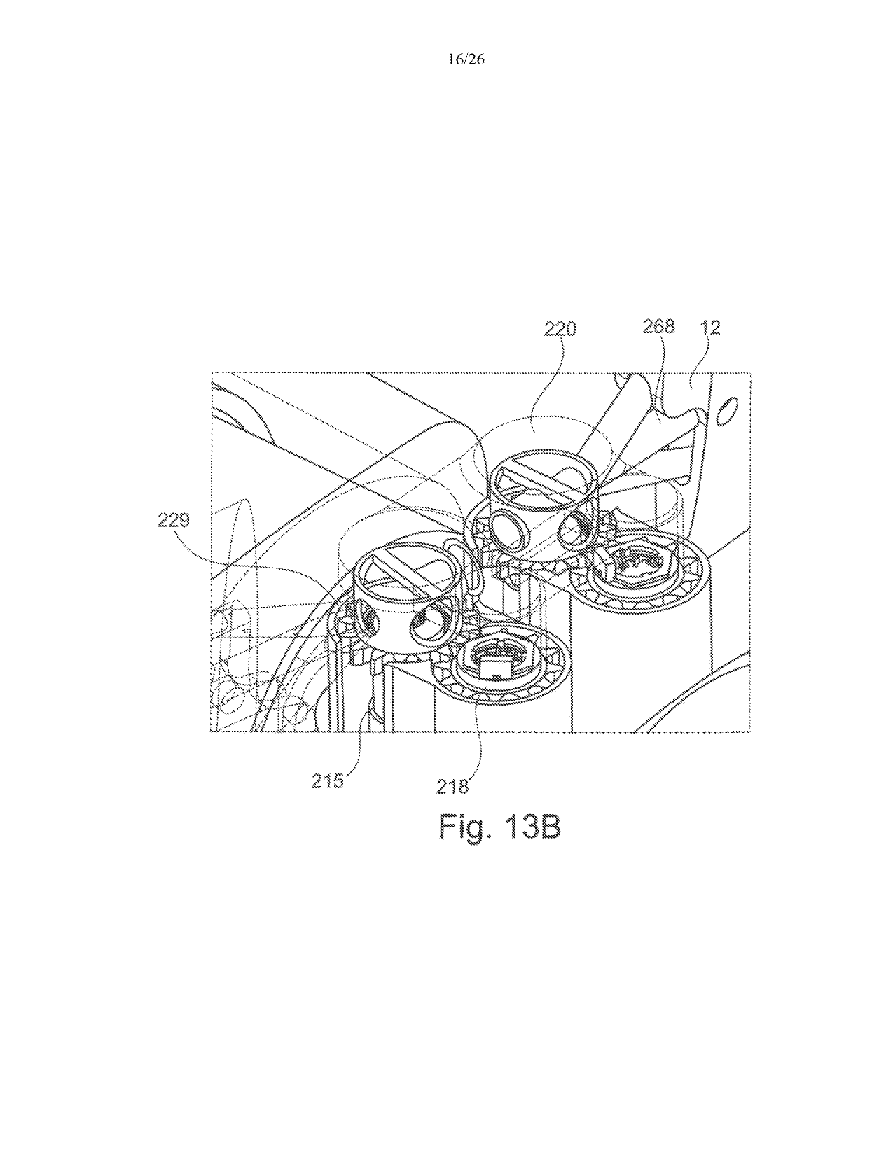

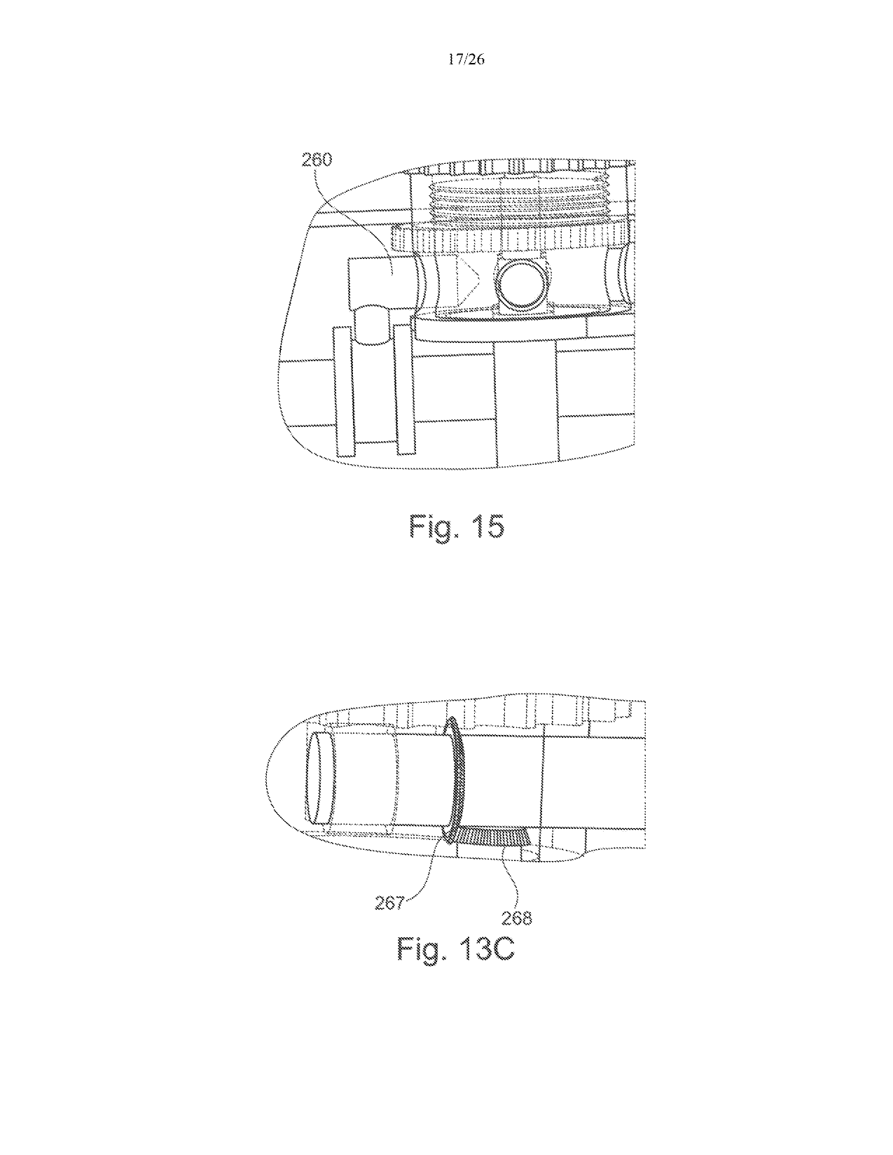

FIGS. 13A to 13C show details for producing a mechanism for controlling the wings,

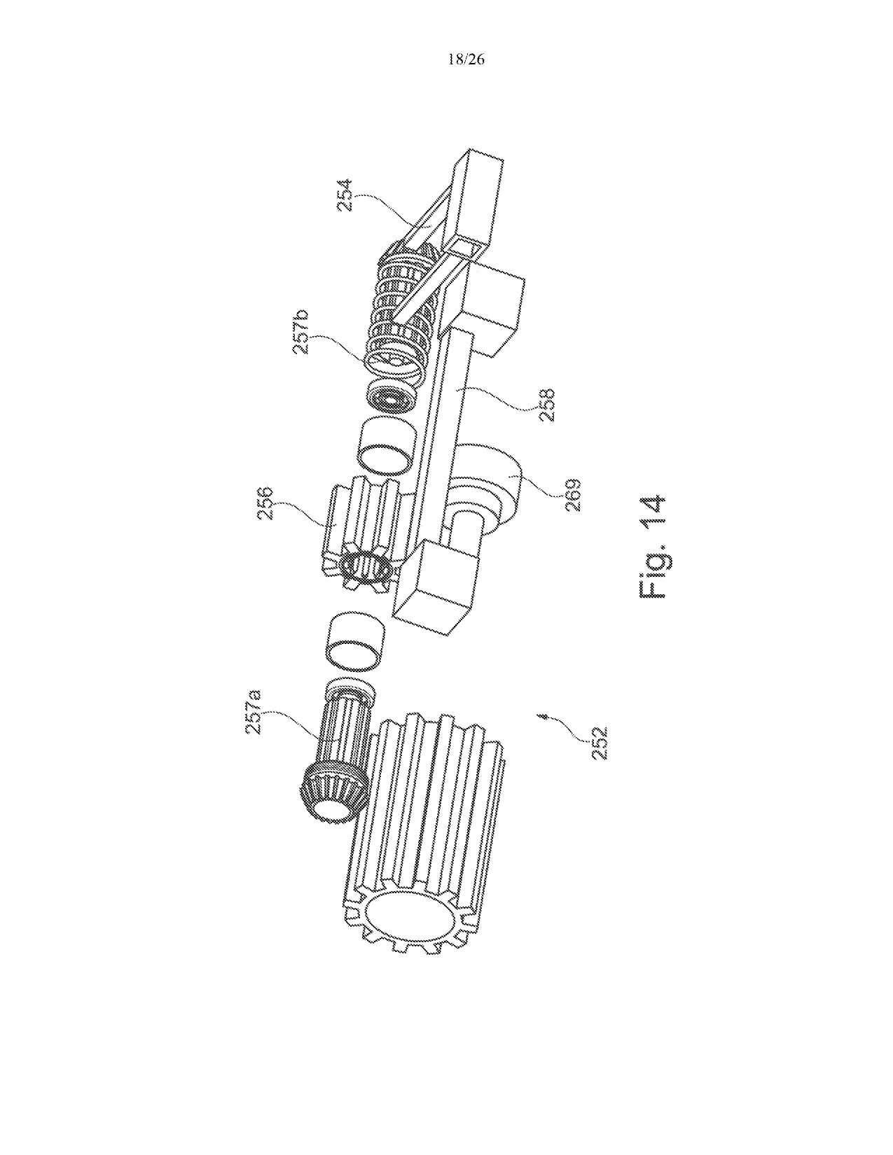

FIG. 14 is an exploded and partial view of the mechanism for controlling the wings,

FIG. 15 shows a detail of a mechanism for locking the wings,

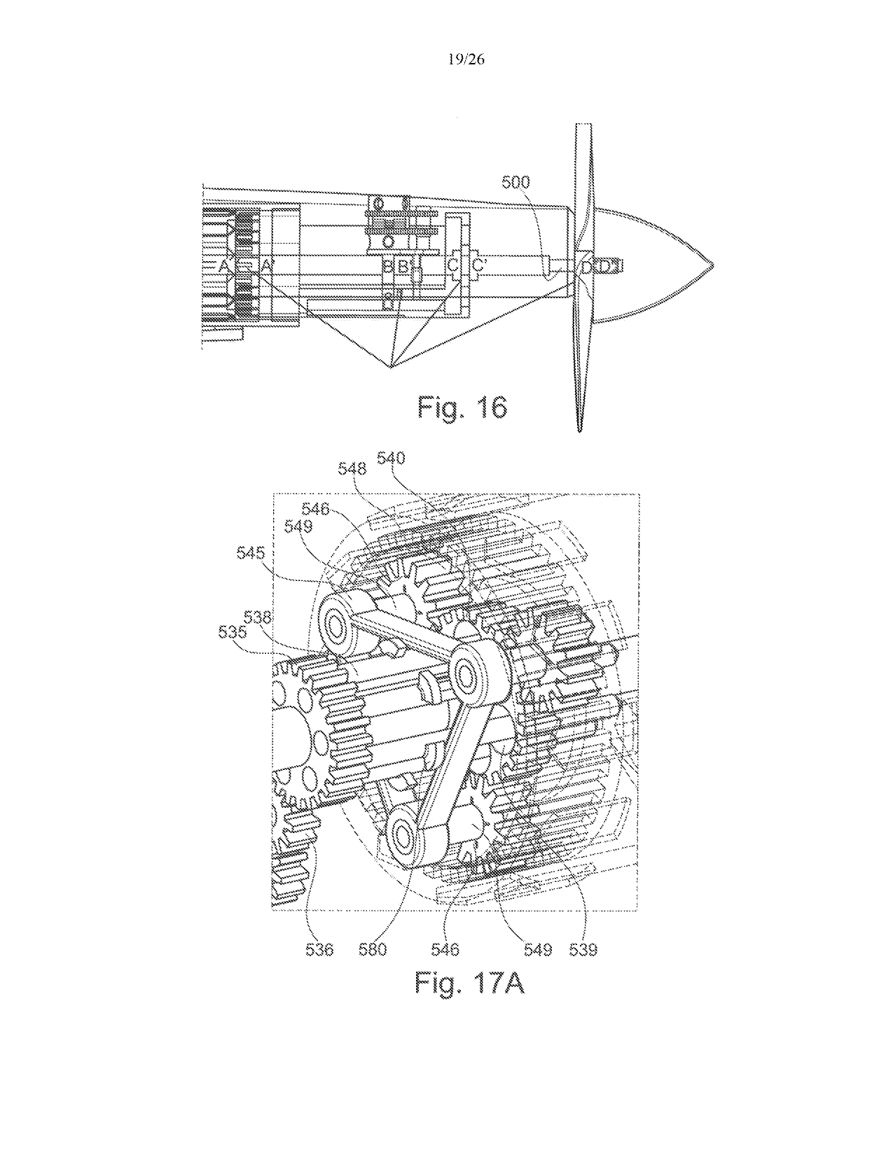

FIG. 16 schematically shows various areas for coupling between mobile elements in the transmission chain from the main motor toward the propeller,

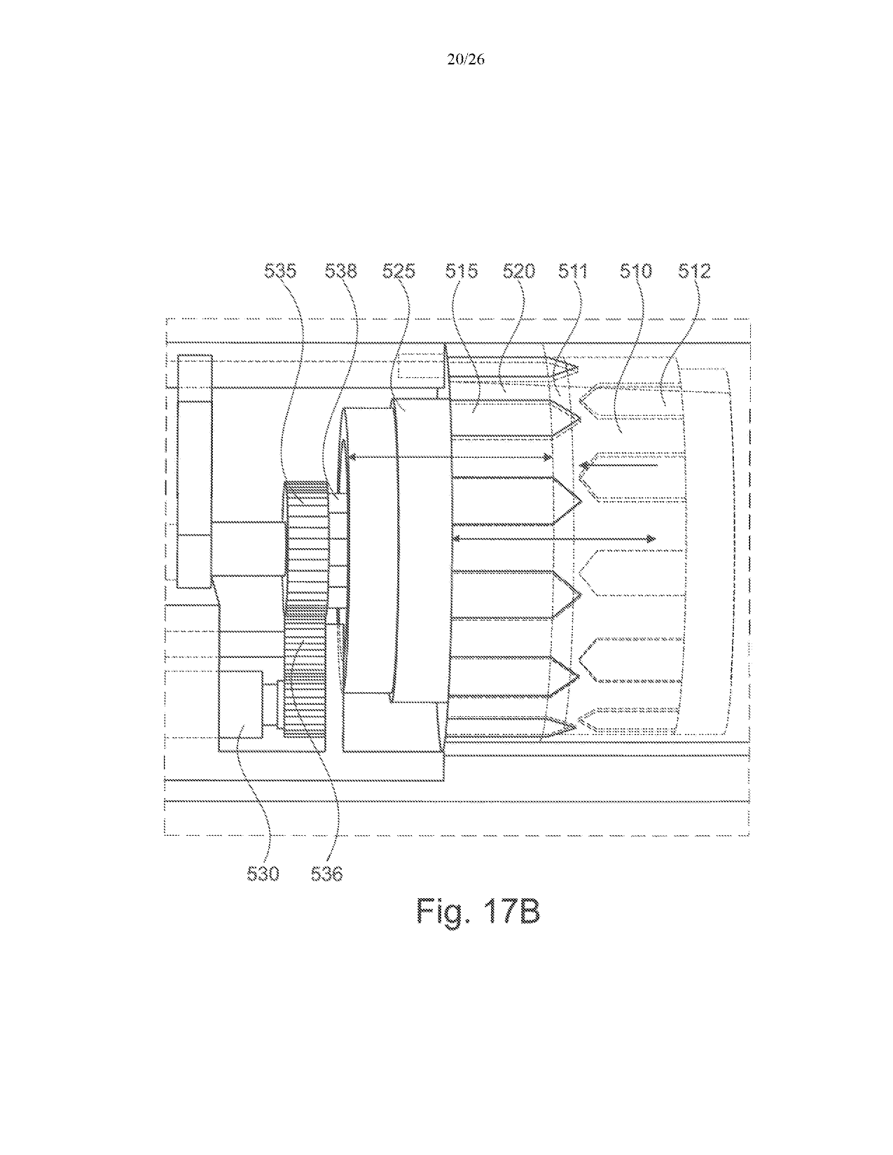

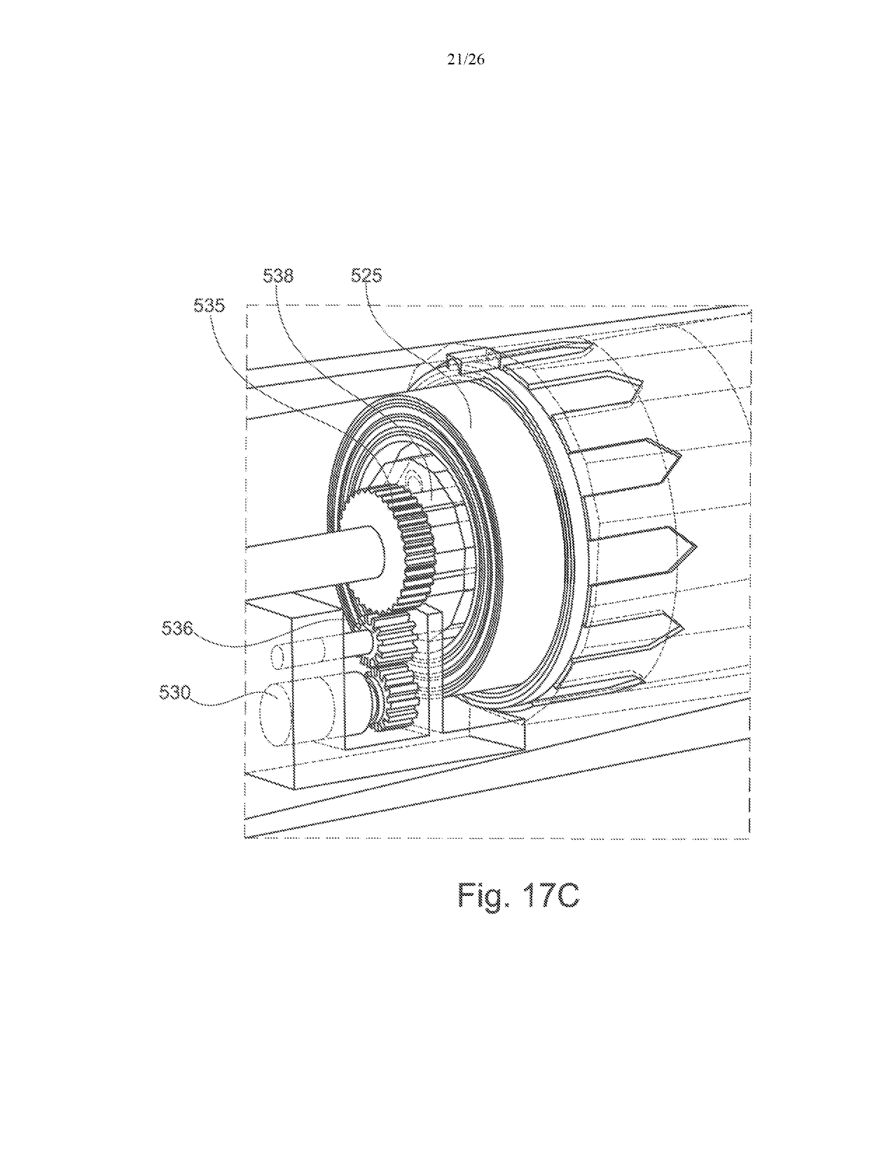

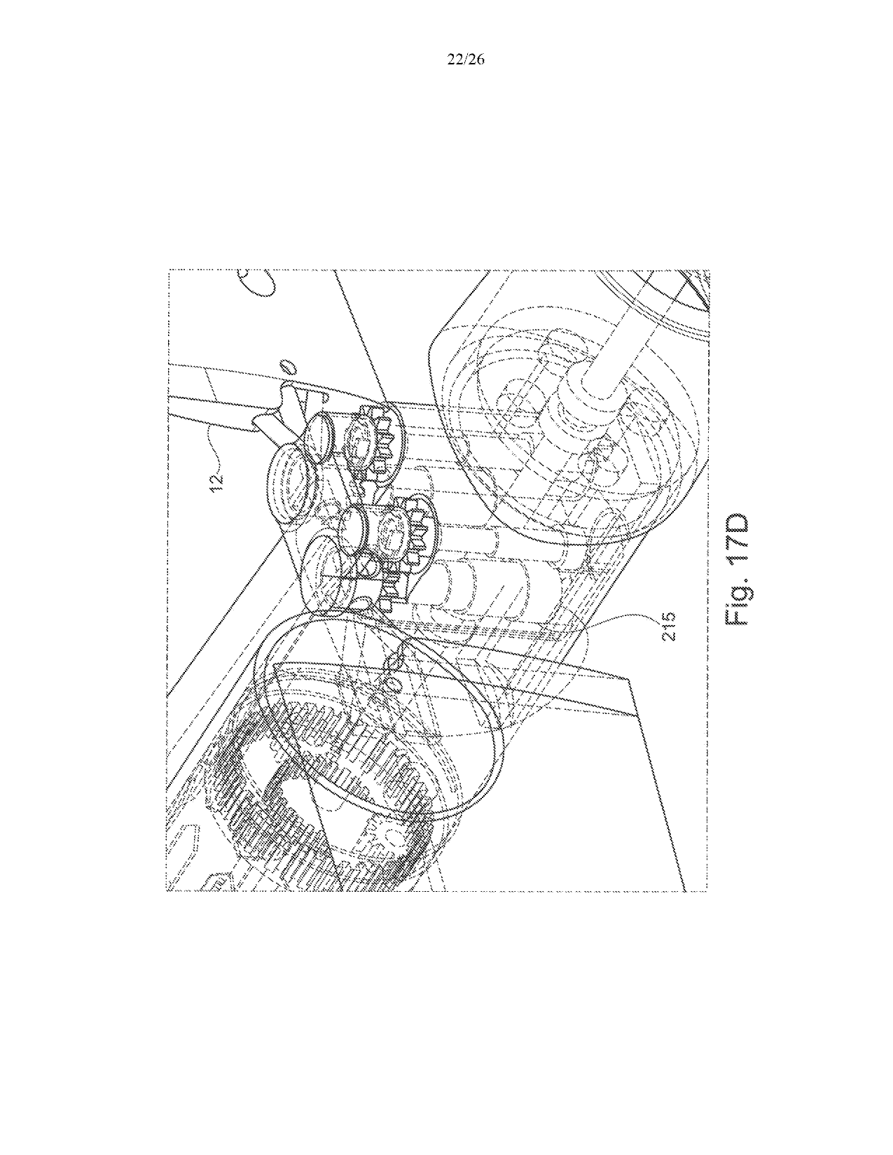

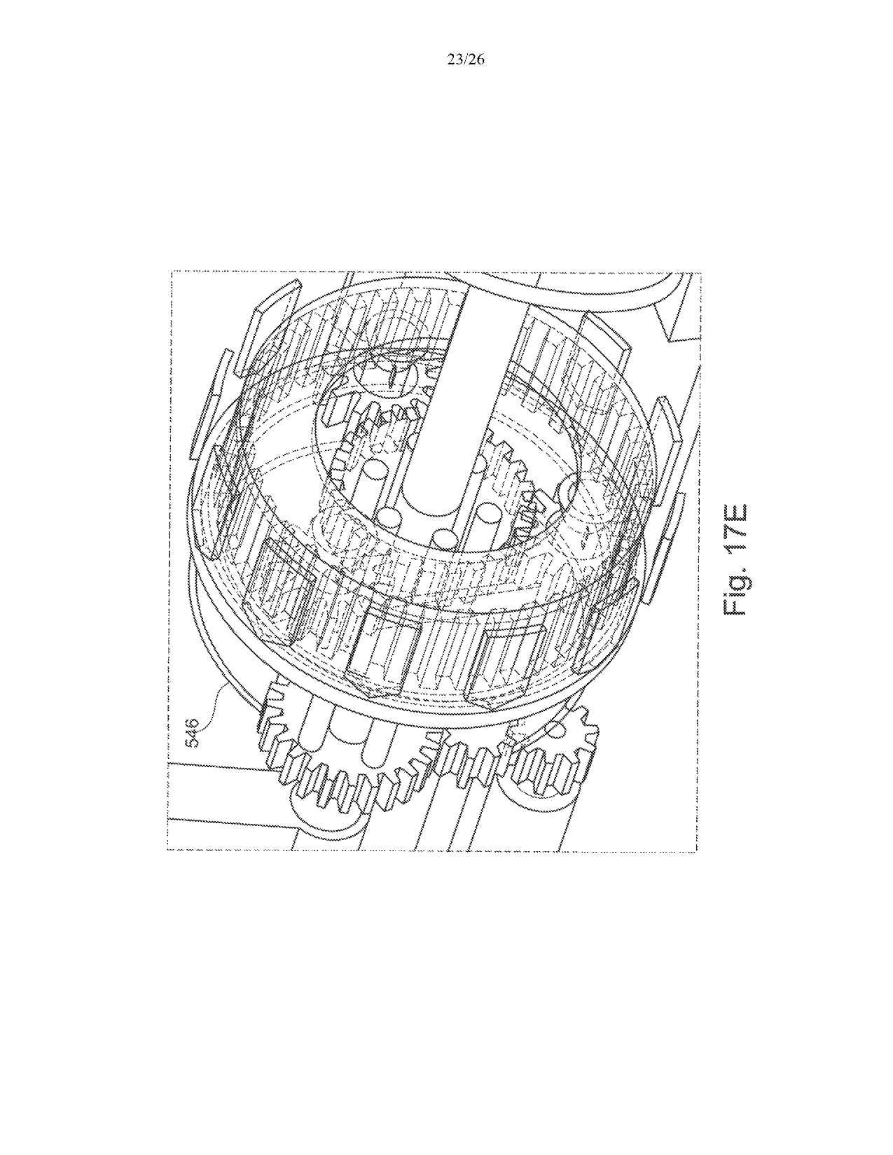

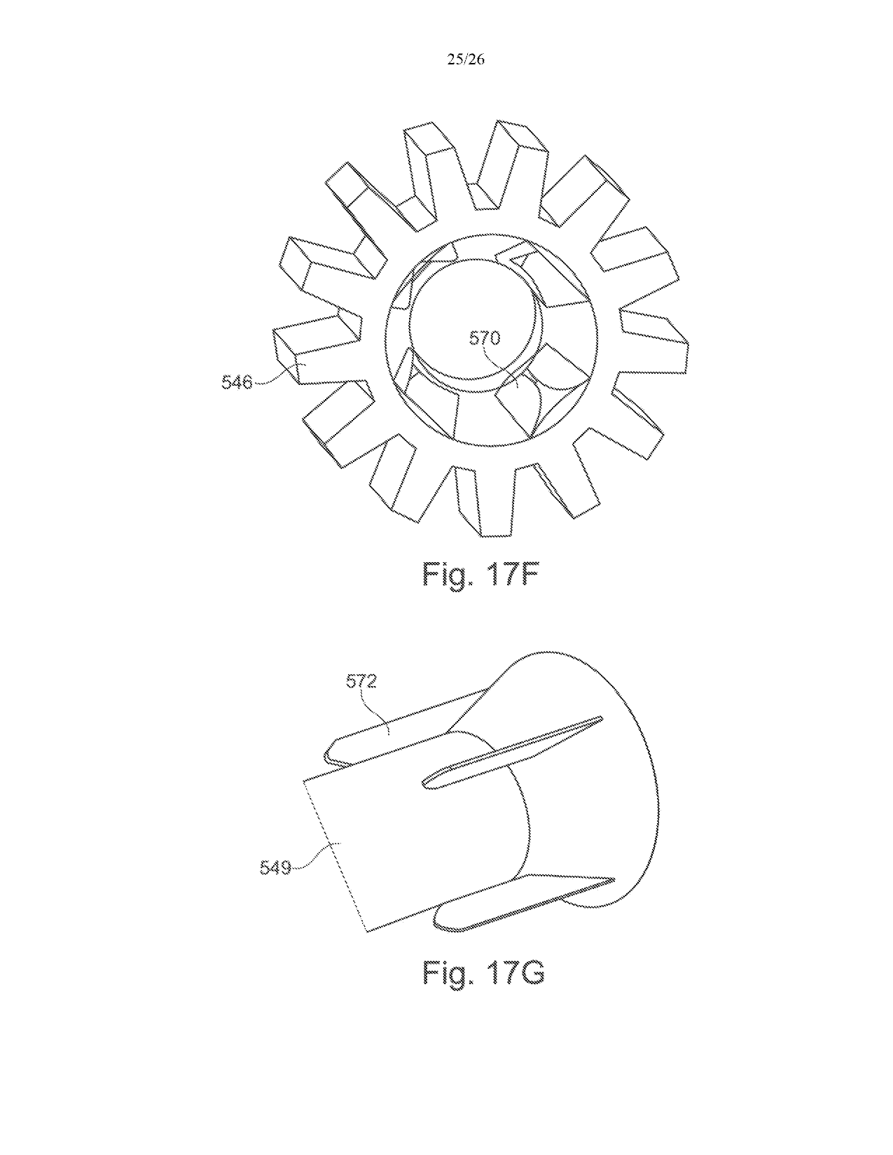

FIGS. 17A to 17H illustrate details for producing the transmission between the motor and the rotating segment bearing the wings,

FIGS. 18A and 18B show an alternative drone,

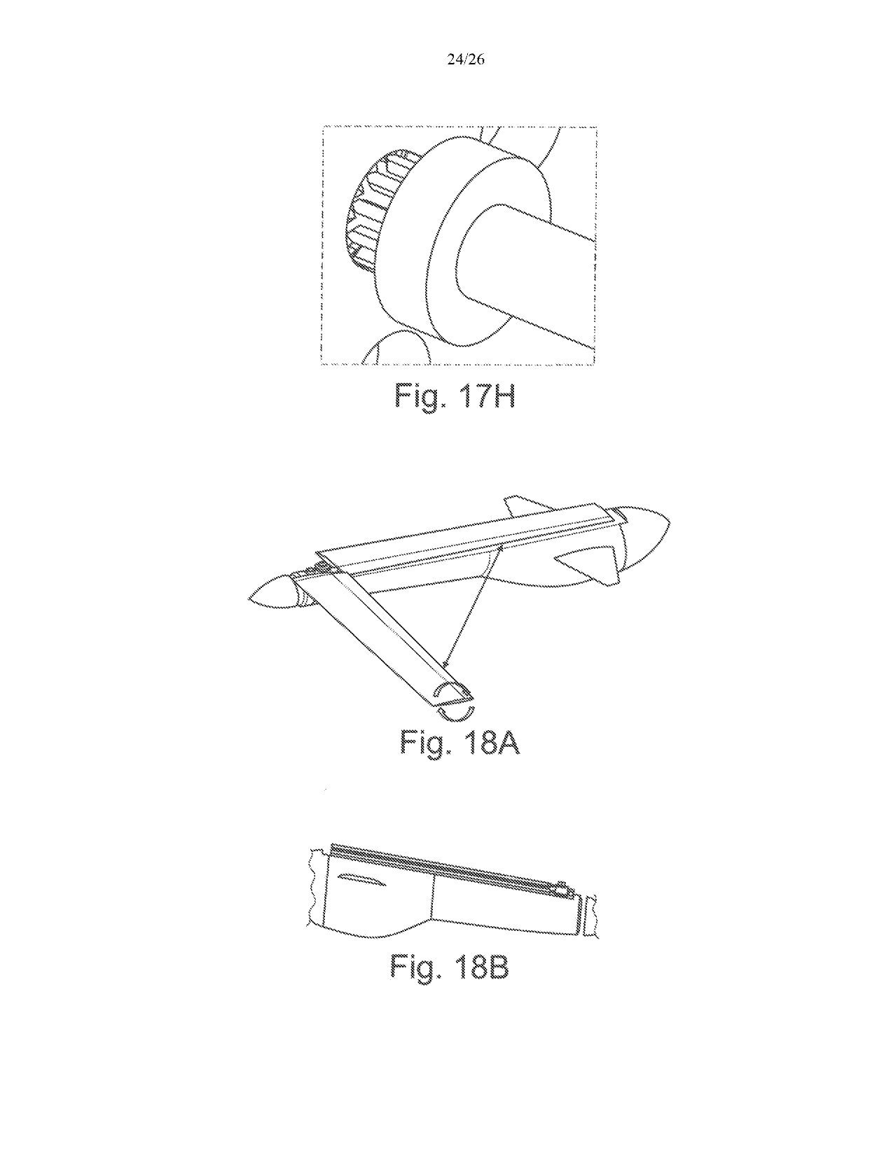

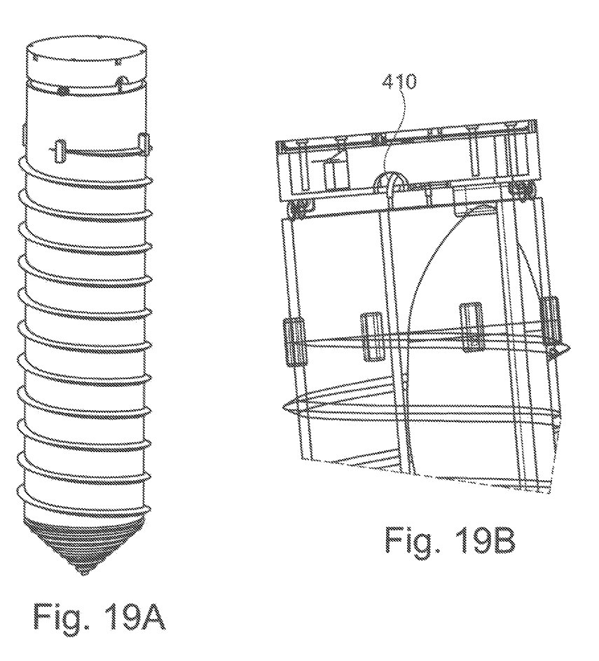

FIGS. 19A and 19B show an alternative launch tube,

FIG. 20 illustrates the possibility of providing the launch tube with an incendiary charge.

The drone 1 shown in FIGS. 1 and 2 includes a fuselage 10 and a wing unit 11 including two wings 12 located at the rear of the fuselage 10 and two ailerons 13, called canards, at the front.

The fuselage 10 is, for example, produced from a composite material, particularly carbon fiber-based. The nose 19 at the front of the drone 1 is preferably produced from two combined polymer materials, namely in the example in question a urethane viscoelastic polymer (for example Sorbothane) coating the nose and a non-Newtonian polymer or non-Newtonian fluid, which is a shear thickening fluid, held by the first polymer. The energy of an impact may thus be dispersed between the two materials. In the example in question, the drone 1 is provided to be launched from a tube 20 that may be seen in FIG. 4A in particular, being ejected therefrom using a propelling charge for example. In the launch configuration, the wings 12 are folded up against the fuselage 10.

The drone 1 includes a propeller 14 located at the rear, for example a three blade propeller, driven by a hidden electric motor, for example of the brushless type, placed inside the fuselage 10.

This motor is powered by an electric power source, for example having a voltage between 20 and 48 V, made up in the example in question by a hydrogen-air fuel cell, connected to one or more hydrogen tanks. The hydrogen is stored, for example, as gas in the compressed state at an initial pressure between 100 and 300 bar at 25° C. In an alternative, the hydrogen is stored differently, for example as metal hydrides, by reacting the hydrogen with certain metal alloys at low pressure.

The drone 1 includes a hold housing a barrel 36, shown in FIG. 8, for example as a cruciform structure, bearing several jettisonable loads 37, of which there are four in the described example. The barrel may revolve in quarter turns around the longitudinal axis thereof, parallel to that of the fuselage, in order to jettison the desired load.

The wings 12 are supported by a structure 40 and by a hinged connection that allows them to assume several configurations depending on the flight stages.

This connection allows the wings 12 to pivot around an axis which makes it possible to change the angle of incidence thereof and to use them as flight control surfaces in order to direct the drone. Actuators provide this function. The wings 12 may thus not have flight control surfaces.

The ailerons 13 also pivot around an axis perpendicular to the fuselage and are controlled in the rotation thereof by actuators placed in the fuselage.

Preferably, this rotation may be performed over 360° at a relatively high speed, for example between 430 and 900 rpm, which makes it possible to use them in the recovery stage in order to produce an anti-rotation moment. The wings 12 may move from a launch configuration, which may be seen in FIGS. 4A and 4B, to a fast flight configuration, which may be seen in FIG. 2, or a slow flight configuration, shown in FIG. 1, and then to a recovery configuration shown in FIG. 3.

Inside the launch tube, the wings 12 are, for example, folded up against the fuselage 10.

In the fast flight configuration, the wings 12 are orientated frontward, forming a forward-swept wing unit. The bearing angle alpha between the longitudinal axis of the fuselage 10 and that of each wing 12 is, for example, between 30° and 90° . For example, the drone has, prior to jettisoning the loads, more than 35% of the mass thereof centered in the front first third. In the fast flight configuration, with the angle alpha equal to 45°, the speed of the drone is, for example, between 75 and 90 knots. A smaller angle alpha, for example of approximately 30°, may allow a higher speed, for example greater than 100 knots.

The length of the fuselage 10 is, for example, between 1.2 m and 2.6 m.

In the slow flight configuration, the wings 12 extend substantially perpendicularly to the fuselage.

The width of the wings 12 may increase toward the free end thereof. The wing end width is, for example, between 18 and 32 cm and the width at the base thereof is between 12 and 26 cm.

In the slow or fast flight configurations, the wings 12 do not revolve around the longitudinal axis X of the fuselage, and form a fixed wing unit 11.

In the recovery configuration, the structure 40 for supporting the wings revolves around the longitudinal axis X such that the wings 12 may form a rotor rotated by the motor for slowing the drone when descending, or keeping it airborne.

In the recovery configuration, the wings 12 assume a reverse pitch with respect to one another. To this end, the wings 12 may be pivoted in the opposite direction by approximately half a turn, as illustrated by the sequence shown in FIGS. 5A to 5C.

In the recovery configuration, the wings are rotated with the support structure by the propulsion motor, for example in the opposite direction to the propeller.

In the alternative illustrated in FIG. 6, the drone includes stowable stabilizers 50.

The stabilizers 50 are retracted inside the fuselage when launching and opened out at least prior to the jettisoning of the loads.

Preferably, these stabilizers 50 are arranged to fasten to the wings 12 in the opened-out configuration, in order to form a “diamond” wing unit which improves lift.

The wings each include an actuator which makes it possible to lock the hooking of the stabilizers to the wings.

The stabilizers 50 are housed between the loads 37 in the returned configuration, as illustrated in FIG. 8, which improves the retention of the loads with regard to the acceleration experienced when launching. The stabilizers particularly make it possible to block the barrel 36 bearing the loads 37 inside the drone against rotation. When the stabilizers block the barrel, the lower chambers thereof are not aligned with the hatch for ejecting the loads, which constitutes a safeguard.

It is advantageous to produce the stabilizers 50 such that they may be used to vary the geometry of the wings 12 by being moved relative to the fuselage.

The degree to which the wings are open may change thanks to the relative wind, which tends to open them. The stabilizers may be used to move them forward and close the angle that they form with the fuselage.

Preferably, the stabilizers 50 are moved using an air brake 100, the movement of which relative to the fuselage provides a force which helps close the stabilizers.

The movement of the stabilizers 50 from the opened-out configuration thereof which may be seen in FIG. 6a to the retracted configuration thereof of FIG. 6b may thus be achieved using a mechanism including the air brake 100, which utilizes the force of the relative wind to bring the stabilizers 50 back into the housing thereof. This air brake 100 may move over rails 101 under the effect of the relative wind and any driving system suitable for using this movement of the air brake may be used. In the example of FIGS. 6A and 6B, the air brake is rigidly connected to notched rods 102 which move therewith and mesh with ratchet wheels 103 in order to form a rack and pinion mechanism. These ratchet wheels have a rotation movement which is transmitted to the stabilizers in order to retract them. Other mechanisms for transforming a linear movement of the air brake into a movement for rotation of the stabilizers may be used.

FIG. 7 shows, in isolation, one of the ratchet wheels 103. The wheel includes a notched peripheral part 104, which meshes with the rods 102 and a hub 105 which bears pawls 106 and which is rigidly connected to an axle placed such that the rotation movement of the hub is accompanied by a movement for return of the stabilizers.

When the air brake 100 is opened out, it tends to move back along the rails 101 and the notched rods 102 rotate the ratchet wheels 103, which causes the return of the stabilizers 50.

The air brake is pushed out of the housing thereof by a linear actuator.

The air brake is unfolded by pivoting on itself, in order to form an angle of approximately 90° with respect to the longitudinal axis of the drone.

Other mechanisms may be used to take advantage the movement of the air brake. For example, FIGS. 6C to 6E show an alternative air brake 100.

The latter includes a pivoting flap 110 borne by a carriage 115 which may slide on rails 116. The flap 110 may assume a fold down position which may be seen in FIG. 6C where it may be inserted into a corresponding housing 111 of the fuselage. The flap includes a runner 112 in which an element 113 connected in a hinged manner to a frame 114 slides. This is hinged at the base thereof on the carriage 115. A gripper 117 may snap into the runner 112 when the flap 110 is folded down. The return of the flap into the housing 111 closes the gripper 117 and frees the flap 110. The flap 110 is hinged on an element 118 which may slide on the carriage 115 and which bears the gripper 117.

The combined movements of the element 113 in the runner, under the action of a non-illustrated cable, connected to this element and controlled by an actuator 119, and of the element 118 along the carriage 115, closes the flap before the return thereof into the housing 111.

FIG. 6D shows the flap 110 before it is folded down in order to be brought back into the housing. It is seen that the element 118 is brought at the end of travel over the carriage 115 by the actuator 119. It then moves back up along the runner 112 which forces the flap to lie flat, until the gripper 117 snaps onto the runner.

The drone 1 forms a robotized aerial carrier which has, in order to fly, a navigation platform illustrated in FIG. 9, including a processor CPU communicating via a bus with a propulsion control, a telemetry system, a transmitter, a receiver, various sensors such as a magnetometer, an inertial measurement unit IMU, an altimeter, and a positioning system using satellites, such as a GPS.

The navigation platform is preferably configured to autonomously operate the drone if this is desired or necessary.

The loads 37 installed on board the drone 1 are provided to be jettisoned during flight.

Preferably, each load 37 is identified by the drone 1 and the latter may control the jettisoning of the loads in the desired order, by pivoting the barrel 36 by a quarter turn in the desired direction and as many times as necessary.

To jettison a load chosen from those installed on board, the barrel 36 is pivoted, if necessary, such as to bring the load to be jettisoned to face the opening of the hold.

In accordance with an advantageous aspect of the invention, each load 37 is connected, when falling, to the drone by an optical fiber 70 as illustrated in FIG. 10.

The latter may be wound on a spool which is unwound as the load 37 falls, at a speed that is sufficient to prevent any tension on the fiber which may damage it. The length of the optical fiber is, for example, between 2000 and 5000 m. The diameter thereof is between 100 and 300 microns for example.

The load 37 is provided, at the rear, with flight control surfaces 39 which make it possible to orientate it when falling in order to guide it toward a predefined objective.

The load 37 includes actuators for acting on these flight control surfaces 39 and inertial sensors such as accelerometers, which provide information on the drift thereof as from the release thereof.

The load 37 includes an electronic circuit which receives the signals from the accelerometers and transmits corresponding data to the drone 1.

The latter may compute, from this data received from the load and from navigation data belonging thereto, the manner in which the load must be guided toward the objective.

The fact that the computation for guiding the load is at least partially undertaken on board the drone makes it possible to largely simplify the electronics on board the load, and to reduce the cost thereof.

The sequence for operating the drone is as follows.

The drone is firstly ejected from the launch tube 20, by any means, as illustrated in FIG. 4B.

Then, as illustrated in FIG. 4C, the wings 12 are opened out, for example to assume the forward-swept flight configuration of FIG. 2 until arriving close to the site to be monitored or upon which one or more loads are to be jettisoned.

The computing power of the navigation platform located on the drone makes it possible to limit the computing power necessary on board the load.

To jettison a load, the barrel 36 is pivoted, if necessary, to bring the load to face the hatch of the hold and this is then opened.

The stabilizers 50 may be opened out in order to improve the stability of the drone and be able to control it more easily after jettisoning the load 37, given the impact of this jettisoning on the center of gravity of the drone.

When the load 37 is jettisoned, the navigation platform of the drone transmits, to the actuators of the flight control surfaces of the load, the necessary corrections for the navigation thereof. At the same time, the platform receives, through the optical fiber 70, an update on the position of the load, which position is obtained using accelerometers installed on board the load which send back the accelerations of the load in three dimensions. With this real-time update on the position of the payload, the navigation platform of the drone computes, in real-time, the deviation with respect to the targeted objective and sends back the corrections to the actuators of the load accordingly.

FIG. 11 shows an alternative embodiment of a drone according to the invention.

In such an alternative, the wings are borne by a rotating structure 200 which allows them to rotate relative to the longitudinal axis of the fuselage in the recovery configuration (rotary wing unit).

This rotating structure 200 may assume a locked configuration where it may not revolve relative to the fuselage, which corresponds to the normal flight configuration (fixed wing unit).

The wings are preferably borne by a lifting structure 210 that allows them to assume a so-called “high” configuration, illustrated in FIG. 11, for normal flight, and a so-called “low” configuration, where the root thereof is brought closer to the longitudinal axis of the fuselage. This low configuration is preferred when the structure 200 revolves relative to the fuselage, in the recovery configuration (rotary wing unit), since it lowers the center of gravity of the wings.

In the example in question, the roots of the wings are borne, as illustrated in FIG. 12, by rotating telescopic columns 215, along which smaller columns 216 extend, for the nonreturn blocking of the roots. The columns 216 bear nonreturn pawls 218 which mesh on teeth 219 at the roots.

Thus, the wings may open out under the action of the rotation of the columns 215, being rotated by the relative wind, and are prevented from retracting under the effect of the pawls 218. FIG. 12 also shows frames 220 for holding the roots.

The columns 215 may be reinforced as illustrated by reinforcements 229, which may be seen particularly in FIG. 13B, against which the columns bear. These reinforcements match the telescopic shape of the columns.

To actuate rotation of the wings, it is possible to provide, as illustrated in FIGS. 13A to 13C, a motor 259. for example of the stepping type, and an actuator 269 which makes it possible to selectively couple this motor to either or both of the wings, thanks to a coupling mechanism 252 shown, in isolation, in FIG. 14.

This mechanism includes a fork 254 which is moved by the linear actuator in order to bring a pinion 256 axially mobile on the axle thereof to mesh selectively with a left 257a or right 257b beveled pinion, which transmits, through intermediate gears 267, the rotation thereof to an axle 268 of the corresponding wing. When the pinion 256 is placed in the middle, the two wings are driven.

The fork 254 may move along a guide 258, under the effect of the actuator 269. Also seen in FIG. 14 is the toothed cylinder which is driven by the stepping motor 240 and which transmits the rotation thereof to the pinion 256. The rotation of the pinions 257a or 257b is transmitted to the corresponding gears 267.

FIG. 15 illustrates the possibility for the roots of the wings to be locked in the low position by engagement of a locking element 260 in a corresponding hole of the root.

A description will be given, with reference to FIGS. 16 and 17A to 17H, of an example of producing the transmission between the main motor and the rotating structure which bears the wings and of system for locking the rotating structure relative to the fuselage.

This transmission is produced such as to assume at least two configurations, namely a first configuration of a locking system where the main motor may drive the propeller while the rotating structure is fixed relative to the fuselage, and a second configuration of the locking system where the main motor may rotate the structure bearing the wings with respect to the fuselage.

The first configuration is used during normal flight and the second during the recovery of the drone or during observation stages with stationary fight.

The transmission is produced, as illustrated in FIG. 16, with several coupling areas, namely a first coupling area A/A′ between a rotating segment bearing the wings and the fuselage, on the main motor side, a second area C/C′ between the rotating segment and the main transmission shaft 500 and a third coupling area D/D′ between the main transmission shaft 500 and the propeller.

The main transmission shaft is normally rotated by the main motor also called the propulsion motor.

B/B′ indicates, in FIG. 16, the possibility of producing, within the rotating structure for supporting the wings, locking/unlocking in the low position of the columns 215 for supporting the roots of the wings described above.

The rotating structure bearing the wings includes a rotating segment 510 which is guided at the axial ends thereof by ball bearings such as to be able to revolve on itself around the longitudinal axis of the fuselage.

The segment 510 is produced with a dog, the teeth 512 of which may mesh with those 515 of a dog formed on a ring gear 520 located at the end of a telescopic structure 525.

This telescopic structure 525 may move, for example under the action of a linear actuator that is not shown, from an opened-out configuration, illustrated in FIG. 17B, where the teeth 512 and 515 are not in mutual engagement, to a retracted configuration illustrated in FIG. 17C, where the dogs are coupled. In the retracted configuration of FIG. 17C, the rotating segment 510 is blocked against rotation relative to the fuselage; this corresponds to the normal flight configuration.

The roots of the wings, when the drone is produced such as to allow them to assume high and low configurations, as is described above, are in the high configuration. The propeller is rotated by the main motor.

In the recovery configuration, illustrated in FIG. 17B, the rotating segment is free with respect to the fuselage, and may be rotated by the main motor, thanks to the transmission provided in the area C/C′ illustrated in FIG. 16, at the rear of the rotating segment, on the propeller side. The propeller is no longer driven, the movement of the shaft having interrupted the transmission between the shaft and the propeller in the area D/D′ of FIG. 16.

Preferably, the locking system is produced such as to be able to assume an intermediate configuration in which the rotating segment 510 bearing the wings is free to revolve with respect to the fuselage without being rotated by the main motor.

An auxiliary motor 530 is provided to rotate the rotating segment 510 in this intermediate configuration; the aim of the intermediate configuration is to make it possible to maneuver the drone by inclining the wings relative to the fuselage in the case of failure of the main flight control surfaces. This may also make it possible to move the wings downward by turning over the drone, and forcing the columns 215 to retract.

It may thus be advantageous to bring the locking system into this intermediate configuration and to wait, before moving into the recovery configuration, for driving the rotating structure using the main motor, for the columns 215 to retract.

The auxiliary motor 530 is coupled to a driving piece 535 by a system of gears 536 such as to be able to rotate it around the longitudinal axis of the transmission main shaft and relative thereto.

The piece 535 includes driving pins 538 which may engage in corresponding housings 539 of an inner sun gear 540 in the aforementioned intermediate configuration.

A planet carrier 545 including three planet gears 546 may transmit the rotation of the sun gear 540 to the ring gear 520, which has a corresponding inner toothing 548.

The planet gears 546 are each axially mobile on a corresponding axle 549 of the planet carrier 545 between a locked position, shown in FIG. 17A, where each planet gear is blocked against rotation on the axle thereof, and an unlocked position, where each planet gear 546 may revolve freely on the corresponding axle 549.

Shown in isolation in FIG. 17F is a planet gear 546 and in FIG. 17G the axle 549. It is seen that the planet gear may be produced with protuberances 570 which may engage corresponding protuberances 572 such as to be rotationally immobilized thereat.

In the normal flight initial configuration, which corresponds to FIGS. 17C and 17E, the planet gears 546 are placed on the smooth parts of the axles 549. This allows the inner sun gear, which revolves with the transmission shaft, to revolve without driving the rotating segment.

To move into the intermediate configuration and configuration for driving the wings via the main motor, the transmission shaft is moved away from the propeller, under the effect of an actuator that is not shown.

The driving piece 535 moves back, and carries along therewith the planet carrier 545 thanks to friction elements in the form of elastic tabs produced 560 with the pins 538 and gripping the arms of the planet carrier.

The moving-back action of the planet carrier causes the planet gears 546 to be blocked on the axles 549. In the position illustrated in FIG. 17A, which corresponds to the intermediate configuration where the auxiliary motor may drive the rotating segment bearing the wings, the rotation of the sun gear 540 under the effect of the rotation of the stepping motor is transmitted via the planet gears 546 to the ring gear 520. The main shaft is not yet coupled to the rotating segment in the area C/C′. The transmission shaft remains coupled to the propeller in the area D/D′.

When the transmission shaft moves back again, the propeller is uncoupled in the area D/D′ thanks, for example, to a splined connection which comes apart.

The shaft meshes in the area C/C′, in order to rotate the rotating segment. The driving piece 535 may disengage from the planet carrier 545 thanks to the flexibility of the tabs 580, such that the planet carrier does not block the moving-back action of the piece 535. The pins 538 thereof may disengage from the inner sun gear 540.

The coupling in the area C/C′ may take place in various manners, for example through engagement of a toothing revolving with the main shaft in a corresponding toothing revolving with the rotating segment, as illustrated in FIG. 17H.

The main shaft may be moved axially by any means, such as a linear actuator.

It is possible to produce the coupling between the propeller and the main shaft, in the area D/D′, in such a way that when the main shaft drives the rotating segment, the main shaft is uncoupled from the propeller. Moreover, it may prove useful for the launch tube 20 to prevent any unauthorized access to the drone.

According to an aspect of the invention, the tube 20 is provided with an incendiary charge 80 shown schematically in FIG. 20, which makes it possible to destroy the drone if unauthorized handling thereof is detected.

The tube 20 may be provided, to this end, with an energy source which powers a control circuit that may exchange information externally, for example via radio link. Thus, the tube 20 may be placed in a passive state allowing the transportation thereof and the installation thereof, or in an active state where it detects any movement and may cause the incendiary charge 80 contained inside to ignite.

The tube 20 may be provided with a seismograph and/or any other sensor that may provide information on the movement of people or equipment nearby. This information may be recorded locally and/or transmitted remotely.

The control circuit may be arranged to ignite the incendiary charge if it detects handling of the tube when it is in the active state.

The tube is arranged such that the combustion of the incendiary charge destroys the drone without producing an explosion by bursting the tube.

The control circuit is preferably arranged to make it possible to remotely activate the launch of the drone. Thus, it is possible to partially bury the drone 1 and leave it in a standby state for a relatively long duration.

When the drone is to be launched, a launch order is transmitted to the tube and the latter triggers the ejection of the cover and the launch operation.

This occurs, for example, under the effect of a strong release of gas resulting from the mixture of mutually reacting compounds.

It may be advantageous for the launch tube to be completely buried and for the cover to contain a pocket making it possible to deposit therein a layer of local coating, for example earth, snow or sand.

It may be advantageous for the ejection of the cover to be pneumatic.

It also proves to be beneficial for the tube to be provided on the external surface thereof, as illustrated in FIG. 19A, with a threading facilitating the burial thereof by screwing.

FIG. 19B shows the possibility of connecting the cover to the body of the tube by a duct 410 that may be disconnected during the ejection of the cover. This duct makes it possible, for example, to actuate a lock releasing the cover prior to the ejection thereof.

FIGS. 18A and 18B illustrate an alternative drone in which the wings may fold down onto one another in the launch configuration. The roots of the wings have two degrees of freedom, one for elevation, called pitch, the other for opening out, called bearing, making it possible to move from the configuration where the two wings are folded down on the fuselage to the opened-out configuration.

Of course, the invention is not limited to the examples given above.

Many alternatives are possible without departing from the scope of the present invention.

For example, the number of on-board payloads may vary, or there may not be any if the drone is intended for surveillance only.

The drone may be launched using means other than from a tube.

The recovery of the drone may take place in a different manner.

1. An assembly including a drone (1) and at least one jettisonable load (37) installed on board the drone, the drone including an on-board data processing system, the at least one jettisonable load including at least one sensor delivering information that may be used to ascertain the trajectory thereof and actuators for controlling flight control surfaces allowing it to be oriented as it falls, the at least one jettisonable load being connected to the drone by an optical fiber (70), the at least one jettisonable load and the drone being arranged to exchange information via the optical fiber while the at least one jettisonable load is falling, the at least one jettisonable load transmitting data originating from said at least one sensor and the drone transmitting data for operating the actuators, established taking into account the data received from the at least one jettisonable load, in order to guide the at least one jettisonable load toward a predefined objective.

2. The assembly as claimed in claim 1, the at least one jettisonable load including the accelerometers and corresponding data being transmitted to the drone via the optical fiber, the corresponding data transmitted by the load to the drone preferably including the trajectory of the load from the release thereof as calculated using accelerometers of the load.

3. The assembly as claimed in claim 1 or 2, the at least one jettisonable load including actuators controlling the movement thereof around roll and pitch axes.

4. The assembly as claimed in one of the preceding claims, the drone including:
a fuselage (10),
two wings (12) configured to move from a flight configuration where the wings form a fixed wing unit, to a recovery configuration of the drone where the wings form a rotary wing unit.

5. The assembly as claimed in claim 4, the wings (12) being borne by a support structure (40; 510) which may revolve relative to the fuselage, the support structure being rotationally fixed when the wings are in the flight configuration and rotating when the wings are in the recovery configuration, the wings then forming a rotor turning relative to the fuselage.

6. The assembly as claimed in claim 4 or 5, the wings (12) being connected in a hinged manner to the fuselage, being configured to move from a launch configuration where the wings are folded down along the fuselage to the flight configuration where the wings are opened out.

7. The assembly as claimed in any one of claims 4 to 6, the wings having a variable geometry in the opened-out configuration.

8. The assembly as claimed in any one of claims 4 to 7, the wings being arranged to form a forward-swept wing unit in the flight configuration.

9. The assembly as claimed in one of claims 4 to 8, the wings being arranged to form a straight wing unit in the flight configuration.

10. The assembly as claimed in any one of claims 4 to 9, the wings rotating such as to assume a reverse angle of incidence with respect to one another in the recovery configuration.

11. The assembly as claimed in any one of the preceding claims, the drone including, at the front, an impact absorbing nose (19).

12. The assembly as claimed in any one of the preceding claims, the drone including canards (13) at the front.

13. The assembly as claimed in claim 12, at least one of the ailerons being rotatable on itself.

14. The assembly as claimed in claim 13, said rotatable aileron being rotated when the wings are in the recovery configuration, in order to revolve on itself in order to apply a counter-rotation moment on the fuselage.

15. The assembly as claimed in any one of the preceding claims, the drone being at least partially housed, before taking off, in a launch tube (20) provided with a propelling charge.

16. The assembly as claimed in claim 15, the launch tube being sealed using an ejectable cover.

17. The assembly as claimed in claim 15 or 16, the tube including a thermal charge (80) which, when lit, causes the destruction of the drone inside the tube.

18. The assembly as claimed in claim 17, the tube being provided with at least one sensor that may detect an unauthorized attempt to move and/or open it, and with a control means for causing the thermal charge to light in the case of an unauthorized attempt to access the inside of the tube or to transport it.

19. The assembly as claimed in claim 17 or 18, the tube being ceramic and produced to resist the heat given off by the thermal charge for the time necessary to destroy the drone.

20. The assembly as claimed in any one of the preceding claims, the drone including a means of propulsion (14) during the flight, driven by a motor.

21. The assembly as claimed in claims 4 and 20, including a transmission driven by the motor in order to rotate the rotor relative to the fuselage in the recovery configuration.

22. The assembly as claimed in any one of the preceding claims, the drone including stabilizers (50) which may move from a retracted configuration to an opened-out configuration during flight, particularly when jettisoning the at least one jettisonable load.

23. The assembly as claimed in any one of the preceding claims, the drone including a hold containing several jettisonable loads (37).

24. The assembly as claimed in claim 23, the hold being placed at the front of the drone.

25. The assembly as claimed in one of claims 23 and 24, the jettisonable loads being placed on a barrel (36) making it possible to select the load to be jettisoned.

26. The assembly as claimed in any one of the preceding claims, the length of the optical fiber being greater than or equal to 3000 m.

27. The assembly as claimed in any one of the preceding claims, including claim 4, the wings (12) having a width increasing toward the free end thereof.

28. The assembly as claimed in any one of the preceding claims, including claim 4, the wings not having ailerons.

29. A method of guiding a load jettisoned from a drone toward an objective, using an assembly as defined in any one of the preceding claims, including the steps of:
transmitting, from the load (37) to the drone (1), data providing information on the movements of the load from the jettison thereof, which data is obtained thanks to one or more sensors installed on board the load,
processing this data using a system installed on board the drone and according to at least this processing transmitting, to the load, data for operating the actuators such as to guide the load toward an objective.

30. The method as claimed in claim 29, including the step of selecting the load before jettison from several installed on board the drone, and of exchanging data with the selected load while it is still on board the drone.

31. The method as claimed in the preceding claims, the selected load being brought into a position for ejection from the drone by rotating a barrel (36) containing several loads, wherein each load may be sent individually by the drone.

32. A method of deploying and recovering a drone of an assembly as defined in any one of claims 1 to 28, including the steps of:
launching the drone from a launch tube by ejecting it from the tube,
causing the wings to open out after exiting the tube in order to assume a flight configuration.

33. The method as claimed in claim 32, including the step of causing the wings to assume a fast flight configuration with a forward-swept wing unit then a slow flight configuration with a straight wing unit.

34. The method as claimed in claim 32 or 33, including the step of causing the wings to assume a rotary wing unit configuration, and slow the drone in the descent thereof by rotating the rotor.

35. The method as claimed in claim 34, including the step of impacting upon the ground using the impact absorbing nose (19) located at the front of the drone.
